(19) United States
(12) Patent Application Publication
(10) Pub. No.: US 2026/0339591 A1
(43) Pub. Date: Oct. 29, 2026

(54) IMAGE DISPLAY METHOD, VEHICLE-MOUNTED DEVICE AND NON-TRANSITORY COMPUTER-READABLE STORAGE MEDIUM

(71) Applicant: BOE TECHNOLOGY GROUP CO., LTD., Beijing (CN)

(72) Inventors: Yan SHEN, Beijing (CN); Xin LIU, Beijing (CN); Xiao ZHANG, Beijing (CN); Liqiang ZHOU, Beijing (CN); Tengwang ZHANG, Beijing (CN); Haotian WU, Beijing (CN); Chao ZHANG, Beijing (CN); Yingjie LI, Beijing (CN)

(73) Assignee: BOE TECHNOLOGY GROUP CO., LTD., Beijing (CN)

(21) Appl. No.: 19/486,455

(22) PCT Filed: Apr. 28, 2024
(86) PCT No.: PCT/CN2024/090255

§ 371 Date: Nov. 21, 2025

(30) Foreign Application Priority Data
May 22, 2023 (CN) 202310580216.9

(51) Int. Cl. G06F 3/14

(52) U.S. Cl. CPC G06F 3/1446

(57) ABSTRACT

An image display method, a vehicle-mounted device and a non-transitory computer-readable storage medium are provided. The image display method includes: obtaining a first display content, wherein the first display content includes a plurality of area display contents respectively corresponding to a plurality of display areas on a display screen; determining at least two areas to be spliced in the first display content based on locations of the plurality of area display contents in the first display content; determining a plurality of splicing parameters based on the at least two areas to be spliced; splicing the plurality of area display contents according to the plurality of splicing parameters to obtain a spliced display content; and displaying the spliced display content in the plurality of display areas on the display screen.

The application claims priority to the Chinese patent application No. 202310580216.9, filed on May 22, 2023, the entire disclosure of which is incorporated herein by reference as part of the present application.

### TECHNICAL FIELD

Embodiments of the present disclosure relate to an image display method, a vehicle-mounted device, and a non-transitory computer-readable storage medium.

### BACKGROUND

Traditional automobile cockpits typically only indicate various driving conditions and often rely on mechanical methods for interaction, resulting in low functional use efficiency. Moreover, traditional button operations are prone to diverting the driver's attention, posing potential safety hazards. With technological advancements, smart cockpits are gradually replacing traditional automobile cockpits. Smart cockpits enable functions such as multi-screen interaction, intelligent speech, and Internet of Vehicles, making interactions between users and the vehicle-mounted system more convenient and efficient. Thus, the user driving experience can be enhanced.

### SUMMARY

At least one embodiment of the present disclosure provides an image display method, comprising: obtaining a first display content, wherein the first display content comprises a plurality of area display contents respectively corresponding to a plurality of display areas on a display screen; determining at least two areas to be spliced in the first display content based on locations of the plurality of area display contents in the first display content; determining a plurality of splicing parameters based on the at least two areas to be spliced; splicing the plurality of area display contents according to the plurality of splicing parameters to obtain a spliced display content; and displaying the spliced display content in the plurality of display areas on the display screen.

For example, in the image display method provided by at least one embodiment of the present disclosure, before obtaining the first display content, further comprising: obtaining a second display content; performing a cropping operation on the second display content based on a resolution of the display screen to obtain the plurality of area display contents; and generating the first display content based on the plurality of area display contents.

For example, in the image display method provided by at least one embodiment of the present disclosure, before obtaining the first display content, further comprising: determining a screen splitting mechanism corresponding to the display screen; partitioning the display screen according to the screen splitting mechanism to determine the plurality of display areas; generating a plurality of views according to a plurality of area sizes respectively corresponding to the plurality of display areas; generating display contents for the plurality of views to obtain the plurality of area display contents; and generating the first display content based on the plurality of area display contents.

For example, in the image display method provided by at least one embodiment of the present disclosure, obtaining the first display content comprises: obtaining an original display content; determining a cropping size based on a resolution of the display screen and a resolution of the original display content; determining a cropping start point; performing a cropping operation on the original display content based on the cropping start point and the cropping size to obtain a cropped display content; processing the cropped display content based on the resolution of the display screen to obtain a processed display content; partitioning the processed display content to obtain the plurality of area display contents; and generating the first display content based on the plurality of area display contents.

For example, in the image display method provided by at least one embodiment of the present disclosure, a location of the cropping start point is a preset location.

For example, in the image display method provided by at least one embodiment of the present disclosure, determining the cropping start point comprises: in response to receiving a sliding operation, determining the cropping start point based on the sliding operation.

For example, in the image display method provided by at least one embodiment of the present disclosure, obtaining the first display content comprises: selecting at least one application in response to a first application display instruction; setting a mapping relationship between the at least one application and the plurality of display areas to determine the plurality of area display contents; and generating the first display content based on the plurality of area display contents.

For example, in the image display method provided by at least one embodiment of the present disclosure, the plurality of display areas comprise at least one application display area and at least one non-application display area; before obtaining the first display content, the image display method further comprises: determining a screen splitting mechanism corresponding to the display screen; partitioning the display screen according to the screen splitting mechanism to determine the plurality of display areas; generating at least one view according to at least one area size respectively corresponding to the at least one non-application display area; and generating a display content for the at least one view to obtain an area display content corresponding to the at least one non-application display area; and obtaining the first display content comprises: selecting at least one application in response to a second application display instruction; setting a mapping relationship between the at least one application and the at least one application display area to determine an area display content corresponding to the at least one application display area; and generating the first display content based on the area display content corresponding to the at least one non-application display area and the area display content corresponding to the at least one application display area.

For example, in the image display method provided by at least one embodiment of the present disclosure, a size of an area occupied by all applications corresponding to each application display area is smaller than or equal to a size of the application display area.

For example, in the image display method provided by at least one embodiment of the present disclosure, the image display method is applied to a vehicle-mounted system of a motor vehicle, and obtaining the first display content comprises: obtaining a plurality of shot contents respectively obtained by a plurality of cameras arranged on the motor vehicle; setting a mapping relationship between the plurality of shot contents and the plurality of display areas to determine the plurality of area display contents; and generating the first display content based on the plurality of area display contents.

For example, in the image display method provided by at least one embodiment of the present disclosure, the image display method is applied to a vehicle-mounted system of a motor vehicle, and a plurality of cameras are arranged on the motor vehicle, and the plurality of cameras are configured to acquire a plurality of shot contents, respectively; the plurality of shot contents are spliced and fused to obtain a spliced shot content; and at least one area display content of the plurality of area display content comprises the spliced shot content.

For example, in the image display method provided by at least one embodiment of the present disclosure, one display area of the plurality of display areas is partitioned into a plurality of sub-areas; and the display content in at least one sub-area of the plurality of sub-areas comprises a graphic button, and the graphic button is clicked or touched to implement a corresponding function.

For example, in the image display method provided by at least one embodiment of the present disclosure, resolutions of at least two display areas of the plurality of display areas are different from each other.

For example, in the image display method provided by at least one embodiment of the present disclosure, the plurality of display areas comprise a first display area, and the first display area comprises a first sub-area and a second sub-area; the first sub-area is configured to display an area display content corresponding to the first display area, and the second sub-area does not display a content; or the area display content corresponding to the first display area comprises a first sub-area display content and a second sub-area display content, the first sub-area is configured to display the first sub-area display content, and the second sub-area is configured to display the second sub-area display content.

For example, in the image display method provided by at least one embodiment of the present disclosure, the image display method is applied to a vehicle-mounted system, and the plurality of display areas comprise an instrument panel area, a central control area, and a co-driver area.

For example, in the image display method provided by at least one embodiment of the present disclosure, the display screen comprises a co-driver display sub-screen corresponding to the co-driver area, the co-driver display sub-screen has a peep-proof function, and an area display content corresponding to the central control area comprises a peep-proof setting button; and the image display method further comprises: displaying a central control peep-proof setting adjusting sub-interface in response to receiving a click operation for the peep-proof setting button, wherein the central control peep-proof setting adjusting sub-interface comprises a peep-proof switch button and a peep-proof adjusting slider; turning on or turning off the peep-proof function of the co-driver area in response to receiving a click operation for the peep-proof switch button; and controlling a peep-proof area of the co-driver area in response to receiving an adjusting operation for the peep-proof adjusting slider.

For example, in the image display method provided by at least one embodiment of the present disclosure, the display screen comprises an instrument panel display sub-screen corresponding to the instrument panel area, an under-screen camera is disposed in the instrument panel display sub-screen, and an area display content corresponding to the instrument panel area comprises a user state prompt; and the image display method further comprises: capturing, by the under-screen camera, face data of a user; determining a current state of the user based on the face data; and updating the user state prompt based on the current state of the user.

For example, in the image display method provided by at least one embodiment of the present disclosure, the plurality of area display contents constitute a complete image or a complete video, the display screen comprises a plurality of display sub-screens, and a display sub-screen with a lowest unit pixel density among the plurality of display sub-screens is a first display sub-screen; splicing the plurality of area display contents according to the plurality of splicing parameters to obtain the spliced display content comprises: adjusting the plurality of area display contents based on the unit pixel density of the first display sub-screen to obtain a plurality of adjusted area display contents, wherein the plurality of adjusted area display contents have a same display resolution; and splicing the plurality of adjusted area display contents according to the plurality of splicing parameters to obtain the spliced display content.

For example, in the image display method provided by at least one embodiment of the present disclosure, the plurality of splicing parameters comprise location data of the at least two areas to be spliced in the first display content.

At least one embodiment of the present disclosure provides a vehicle-mounted device which comprises a display screen, a splicing apparatus, and a system chip; the system chip is configured to: obtain a first display content, wherein the first display content comprises a plurality of area display contents respectively corresponding to a plurality of display areas on a display screen; determine at least two areas to be spliced in the first display content based on locations of the plurality of area display contents in the first display content; determine a plurality of splicing parameters based on the at least two areas to be spliced; and output the plurality of splicing parameters to the splicing apparatus; the splicing apparatus is configured to splice the plurality of area display contents according to the plurality of splicing parameters to obtain a spliced display content; and the display screen is configured to display the spliced display content in the plurality of display areas.

For example, the vehicle-mounted device provided by at least one embodiment of the present disclosure further comprises an interface design apparatus; the interface design apparatus is configured to: obtain a second display content; perform a cropping operation on the second display content based on a resolution of the display screen to obtain the plurality of area display contents; and generate the first display content based on the plurality of area display contents.

For example, the vehicle-mounted device provided by at least one embodiment of the present disclosure further comprises a content generation apparatus; the content generation apparatus is configured to: obtain display contents generated for a plurality of views respectively corresponding to the plurality of display areas to obtain the plurality of area display contents; and generate the first display content based on the plurality of area display contents; the plurality of views are determined by a method as follows: determining a screen splitting mechanism corresponding to the display screen; partitioning the display screen according to the screen splitting mechanism to determine the plurality of display areas; and generating the plurality of views according to a plurality of area sizes respectively corresponding to the plurality of display areas.

For example, in the vehicle-mounted device provided by at least one embodiment of the present disclosure, when performing an operation of obtaining the first display content, the system chip is configured to: obtain an original display content; determine a cropping size based on a resolution of the display screen and a resolution of the original display content; determine a cropping start point; perform a cropping operation on the original display content based on the cropping start point and the cropping size to obtain a cropped display content; process the cropped display content based on the resolution of the display screen to obtain a processed display content; partition the processed display content to obtain the plurality of area display contents; and generate the first display content based on the plurality of area display contents.

For example, in the vehicle-mounted device provided by at least one embodiment of the present disclosure, a location of the cropping start point is a preset location.

For example, in the vehicle-mounted device provided by at least one embodiment of the present disclosure, when performing an operation of determining the cropping start point, the system chip is configured to, in response to receiving a sliding operation, determine the cropping start point based on the sliding operation.

For example, in the vehicle-mounted device provided by at least one embodiment of the present disclosure, when performing an operation of obtaining the first display content, the system chip is configured to: select at least one application in response to a first application display instruction; set a mapping relationship between the at least one application and the plurality of display areas to determine the plurality of area display contents; and generate the first display content based on the plurality of area display contents.

For example, in the vehicle-mounted device provided by at least one embodiment of the present disclosure, the plurality of display areas comprise at least one application display area and at least one non-application display area; the vehicle-mounted device further comprises a content generation apparatus configured to obtain a display content generated for at least one view respectively corresponding to the at least one non-application display area to obtain an area display content corresponding to the at least one non-application display area; wherein the at least one view is determined by a method as follows: determining a screen splitting mechanism corresponding to the display screen; partitioning the display screen according to the screen splitting mechanism to determine the plurality of display areas; and generating the at least one view according to at least one area size respectively corresponding to the at least one non-application display area; and when performing an operation of obtaining the first display content, the system chip is configured to: select at least one application in response to a second application display instruction; set a mapping relationship between the at least one application and the at least one application display area to determine an area display content corresponding to the at least one application display area; and generate the first display content based on the area display content corresponding to the at least one non-application display area and the area display content corresponding to the at least one application display area.

For example, in the vehicle-mounted device provided by at least one embodiment of the present disclosure, the vehicle-mounted device is applied to a motor vehicle, when performing an operation of obtaining the first display content, the system chip is configured to: obtain a plurality of shot contents respectively obtained by a plurality of cameras arranged on the motor vehicle; set a mapping relationship between the plurality of shot contents and the plurality of display areas to determine the plurality of area display contents; and generate the first display content based on the plurality of area display contents.

For example, in the vehicle-mounted device provided by at least one embodiment of the present disclosure, the plurality of display areas comprise a first display area, and the first display area comprises a first sub-area and a second sub-area; the first sub-area is configured to display an area display content corresponding to the first display area, and the second sub-area does not display a content; or the area display content corresponding to the first display area comprises a first sub-area display content and a second sub-area display content, the first sub-area is configured to display the first sub-area display content, and the second sub-area is configured to display the second sub-area display content.

For example, in the vehicle-mounted device provided by at least one embodiment of the present disclosure, the display screen comprises a plurality of display sub-screens, and unit pixel densities of at least two display sub-screens of the plurality of display sub-screens are different from each other.

For example, in the vehicle-mounted device provided by at least one embodiment of the present disclosure, the plurality of area display contents constitute a complete image or a complete video, and a display sub-screen with a lowest unit pixel density among the plurality of display sub-screens is a first display sub-screen; when performing an operation of splicing the plurality of area display contents according to the plurality of splicing parameters to obtain the spliced display content, the splicing apparatus is configured to: adjust the plurality of area display contents based on the unit pixel density of the first display sub-screen to obtain a plurality of adjusted area display contents, wherein the plurality of adjusted area display contents have a same display resolution; and splice the plurality of adjusted area display contents according to the plurality of splicing parameters to obtain the spliced display content.

For example, in the vehicle-mounted device provided by at least one embodiment of the present disclosure, the plurality of display areas comprise an instrument panel area, the display screen comprises an instrument panel display sub-screen corresponding to the instrument panel area, and an under-screen camera is disposed in the instrument panel display sub-screen.

For example, in the vehicle-mounted device provided by at least one embodiment of the present disclosure, an area display content corresponding to the instrument panel area comprises a user state prompt, and the system chip is further configured to: obtain face data of a user captured by the under-screen camera; determine a current state of the user based on the face data; and update the user state prompt based on the current state of the user.

For example, in the vehicle-mounted device provided by at least one embodiment of the present disclosure, the plurality of display areas comprise a co-driver area, the display screen comprises a co-driver display sub-screen corresponding to the co-driver area, and the co-driver display sub-screen has a peep-proof function.

For example, in the vehicle-mounted device provided by at least one embodiment of the present disclosure, the plurality of display areas further comprise a central control area, an area display content corresponding to the central control area comprises a peep-proof setting button, and the system chip is further configured to: display a central control peep-proof setting adjusting sub-interface in response to receiving a click operation for the peep-proof setting button, wherein the central control peep-proof setting adjusting sub-interface comprises a peep-proof switch button and a peep-proof adjusting slider; turn on or turn off the peep-proof function of the co-driver area in response to receiving a click operation for the peep-proof switch button; and control a peep-proof area of the co-driver area in response to receiving an adjusting operation for the peep-proof adjusting slider.

For example, in the vehicle-mounted device provided by at least one embodiment of the present disclosure, the plurality of splicing parameters comprise location data of the at least two areas to be spliced in the first display content.

At least one embodiment of the present disclosure provides a non-transitory computer-readable storage medium; computer-executable instructions are stored on the non-transitory computer-readable storage medium; the computer-executable instructions, when executed by a processor, cause the image display method according to any one of the embodiments provided by the present disclosure to be implemented.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a flowchart of an image display method provided by at least one embodiment of the present disclosure;

FIG. 2A is a schematic diagram of a plurality of display areas provided by at least one embodiment of the present disclosure;

FIG. 2B is a schematic diagram of a software development area provided by at least one embodiment of the present disclosure;

FIG. 2C is a schematic diagram of another software development area provided by at least one embodiment of the present disclosure;

FIG. 2D is a schematic diagram of yet another software development area provided by at least one embodiment of the present disclosure;

FIG. 3 is a schematic diagram of a display content of a standard user interface and a display effect after splicing provided by at least one embodiment of the present disclosure;

FIG. 4 is a diagram showing a process of making and displaying a customized video provided by at least one embodiment of the present disclosure;

FIG. 5 is a diagram showing a process of displaying a plurality of views in a screen splitting manner provided by at least one embodiment of the present disclosure;

FIG. 6 is a flowchart of displaying a plurality of views in a screen splitting manner provided by at least one embodiment of the present disclosure;

FIG. 7A is a diagram showing a process of dynamic splicing and displaying provided by at least one embodiment of the present disclosure;

FIG. 7B is a schematic diagram of determining a cropping start point provided by at least one embodiment of the present disclosure;

FIG. 8 is a schematic diagram of displaying an application provided by at least one embodiment of the present disclosure;

FIG. 9A is a schematic diagram showing a process of displaying a plurality of applications in a screen splitting manner provided by at least one embodiment of the present disclosure;

FIG. 9B is a flowchart of displaying an application provided by at least one embodiment of the present disclosure;

FIG. 10A is a diagram showing a process displaying one application in a co-driver area provided by at least one embodiment of the present disclosure;

FIG. 10B is a diagram showing a process displaying two applications in the co-driver area provided by at least one embodiment of the present disclosure;

FIG. 11A is a schematic diagram of a motor vehicle provided by at least one embodiment of the present disclosure;

FIG. 11B is a schematic diagram of a spliced full-scene assisted driving picture provided by at least one embodiment of the present disclosure;

FIG. 11C is a schematic diagram of displaying a plurality of shot contents in a screen splitting manner provided by at least one embodiment of the present disclosure;

FIG. 12 is a schematic diagram of a first display content provided by at least one embodiment of the present disclosure;

FIG. 13 is a schematic diagram of a vehicle-mounted device provided by at least one embodiment of the present disclosure;

FIG. 14 is an exploded diagram of areas in a screen splitting technique provided by at least one embodiment of the present disclosure;

FIG. 15A is a structural relationship diagram of a software screen split structure of a vehicle-mounted system provided by at least one embodiment of the present disclosure;

FIG. 15B is an overall schematic diagram of functional modules of the vehicle-mounted system provided by at least one embodiment of the present disclosure;

FIG. 16 is a schematic diagram of module interaction of a vehicle-mounted system provided by at least one embodiment of the present disclosure;

FIG. 17 is a schematic diagram of interface elements of an instrument panel area provided by at least one embodiment of the present disclosure;

FIG. 18 is a flowchart of user state detection provided by at least one embodiment of the present disclosure;

FIG. 19 is a schematic diagram of interface elements of a central control area provided by at least one embodiment of the present disclosure;

FIG. 20 is a schematic diagram of a central control peep-proof setting adjusting sub-interface provided by at least one embodiment of the present disclosure;

FIG. 21 is a schematic diagram of a peep-proof display interface of a co-driver area provided by at least one embodiment of the present disclosure;

FIG. 22 is a flowchart of turning on a peep-proof function provided by at least one embodiment of the present disclosure;

FIG. 23 is a schematic diagram of a user interaction operation provided by at least one embodiment of the present disclosure;

FIG. 24 is an overall flowchart of a vehicle-mounted system provided by at least one embodiment of the present disclosure; and

FIG. 25 is a schematic diagram of a non-transitory computer-readable storage medium provided by at least one embodiment of the present disclosure.

### DETAILED DESCRIPTION

In order to make objects, technical details and advantages of the embodiments of the disclosure apparent, the technical solutions of the embodiments will be described in a clear and fully understandable way in connection with the drawings related to the embodiments of the disclosure. Apparently, the described embodiments are just a part but not all of the embodiments of the disclosure. Based on the described embodiments herein, those skilled in the art can obtain other embodiment (s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms “comprise,” “comprising,” “comprise,” “comprising,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may comprise an electrical connection, directly or indirectly. “On,” “under,” “left,” “right” and the like are only used to indicate relative position relationship, and when the position of the object which is described is changed, the relative position relationship may be changed accordingly.

In order to keep the following description of the embodiments of the present disclosure clear and concise, the present disclosure omits a detailed description of some known functions and known components.

At least one embodiment of the present disclosure provides an image display method including: obtaining a first display content, in which the first display content includes a plurality of area display contents respectively corresponding to a plurality of display areas on a display screen; determining at least two areas to be spliced in the first display content based on locations of the plurality of area display contents in the first display content; determining a plurality of splicing parameters based on the at least two areas to be spliced; splicing the plurality of area display contents according to the plurality of splicing parameters to obtain a spliced display content; and displaying the spliced display content in the plurality of display areas on the display screen.

The image display method provided by the embodiments of the present disclosure may be applied to a full-scene assisted driving scenario based on a vehicle-mounted smart cockpit. The image display method can achieve full-screen display on a vehicle-mounted display screen by a splicing approach, realizing compatibility of the vehicle-mounted display screen with current standard videos and images, and exhibiting high practicality and very broad application prospects.

Embodiments of the present disclosure further provide a vehicle-mounted device and a non-transitory computer-readable storage medium. The aforementioned image display method may be applied to the vehicle-mounted device provided by the embodiments of the present disclosure. The vehicle-mounted device may be configured in transportation means such as motor vehicles. The motor vehicles may include oil-fueled automobiles, electric automobile, and the like. In the embodiments of the present disclosure, unless otherwise specified, the vehicle-mounted device is described as being configured in an automobile by way of example. However, the present disclosure is not limited thereto. An application object of the vehicle-mounted device may be specifically determined according to actual application scenarios and requirements.

It needs to be noted that, in the following description of the present disclosure, the term “resolution of a display screen” refers to a physical resolution of the display screen, which is an inherent parameter of the display screen and cannot be adjusted and indicates the maximum number of pixels the display screen can display. The term “resolution of a display content” refers to a video/image resolution of the display content (i.e., image resolution in the case where the display content is an image, and video resolution in the case where the display content is a video), which determines the level of details in a video and an image and indicates the amount of information stored in the video/image. The term “display resolution” refers to the resolution when the display screen shows the display content, which may be lower than the physical resolution of the display screen itself.

The embodiments of the present disclosure are described in detail below with reference to the accompanying drawings, but the present disclosure is not limited to these specific embodiments.

FIG. 1 is a flowchart of an image display method provided by at least one embodiment of the present disclosure.

The image display method provided by the embodiments of the present disclosure may be implemented by a system chip in a vehicle-mounted device. The specific structure and functions of the vehicle-mounted device will be described later. For example, as shown in FIG. 1, the image display method provided by one embodiment of the present disclosure includes step S100 to step S104.

In step S100, a first display content is obtained. For example, the first display content includes a plurality of area display contents respectively corresponding to a plurality of display areas on a display screen. The first display content may be an image, a video, an interactive interface view, or the like, or may be any content, such as an application, that can be displayed on the display screen. It needs to be noted that one or more of the plurality of area display contents may be blank data. In this case, the blank area display content correspondingly displays or does not display a content.

In step S101, at least two areas to be spliced in the first display content are determined based on locations of the plurality of area display contents in the first display content.

In step S102, a plurality of splicing parameters are determined based on the at least two areas to be spliced.

In step S103, the plurality of area display contents are spliced according to the plurality of splicing parameters to obtain a spliced display content.

In step S104, the spliced display content is displayed in the plurality of display areas on the display screen.

The display screen may be a vehicle-mounted display screen and be a strip-shaped display screen. For example, in some embodiments, the display screen may be a complete screen, such as a 42.2-inch strip-shaped touch display screen with a resolution of 10496 (pixels)*1040 (pixels) and a refresh rate of 60 hertz (Hz). For example, in some other embodiments, the display screen includes a plurality of display sub-screens, that is, the display screen may be formed by joining a plurality of display sub-screens together so that the manufacturing difficulty and the manufacturing cost of the display screen can be reduced. In this case, at least some display sub-screens may have different resolutions and/or unit pixel densities from one another, and may also have different refresh rates from one another. However, the embodiments of the present disclosure are not limited thereto. In some embodiments, a plurality of display sub-screens may have the same resolution and/or unit pixel density, and may also have the same refresh rate. In the following description, unless otherwise specified, the descriptions take the case where the resolution of the display screen is TOK*1K (10496*1040) as an example. However, the resolution of the display screen in the embodiments of the present disclosure is not limited to 10496*1040 and may be set according to specific circumstances. Furthermore, in the description of the present disclosure, the resolutions are expressed in units of pixels.

When the display screen is formed by joining a plurality of display sub-screens, each display area may correspond to one display sub-screen, or may correspond to two or more display sub-screens. In other words, a display area may extend across the plurality of display sub-screens. Conversely, each display sub-screen may correspond to a plurality of display areas. This is not specifically limited in the present disclosure.

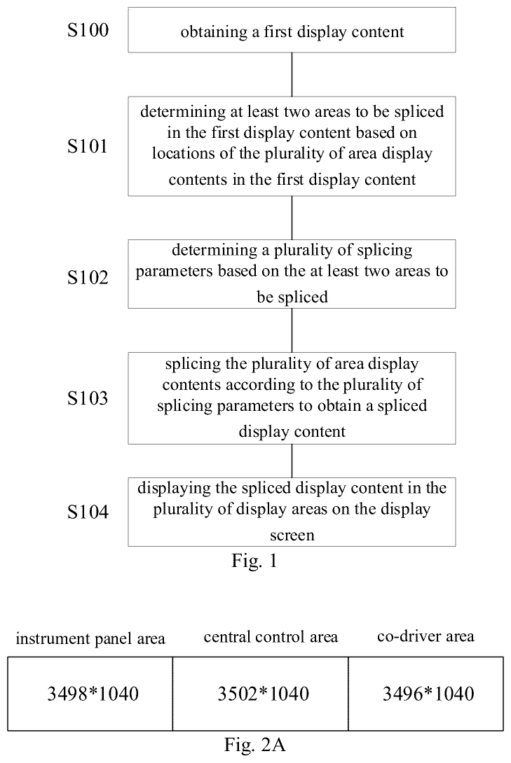

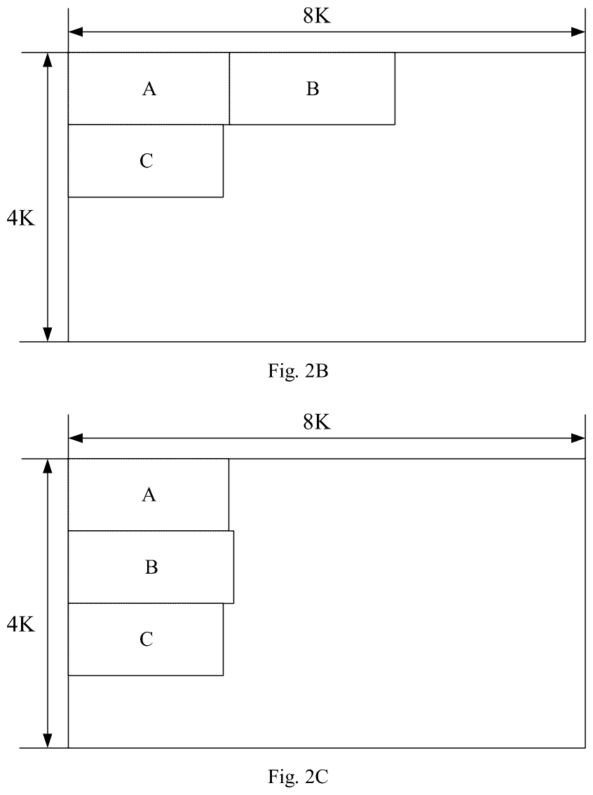

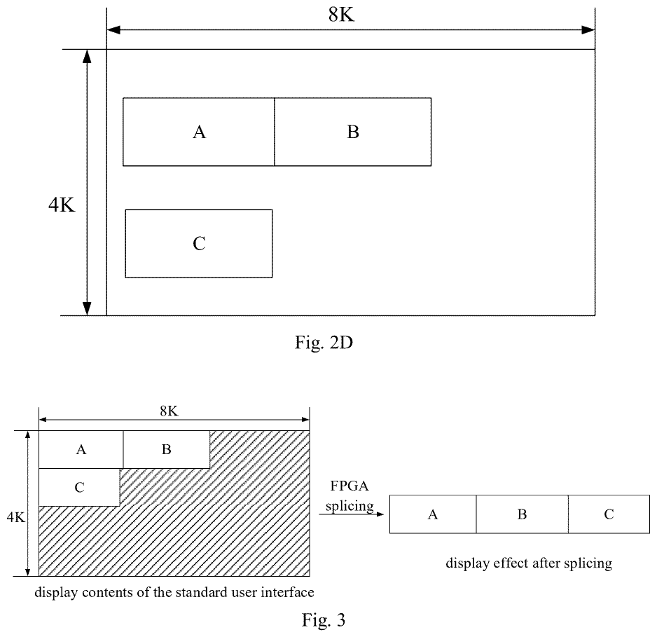

The embodiments of the present disclosure do not impose any specific limitation on the number of the plurality of display areas on the display screen. The number of the plurality of display areas is set according to actual circumstances, e.g., 3, 4, or 5. As shown in FIG. 2A, in one embodiment, the display screen may include three display areas.

For example, at least two display areas of the plurality of display areas may have different resolutions from each other. For example, as shown in FIG. 2A, the three display areas have different resolutions from one another.

For example, in one embodiment, the image display method is applied to a vehicle-mounted system. The plurality of display areas include an instrument panel area, a central control area, and a co-driver area. For example, in some embodiments, as shown in FIG. 2A, the instrument panel area has a resolution of 3498*1040, the central control area has a resolution of 3502*1040, and the co-driver area has a resolution of 3496*1040.

As shown in FIG. 2B, in the software development and design process, a standard software development area has a dimension of 8K*4K (7680*4320). To accommodate a strip-shaped vehicle-mounted display screen, an actual development area has a size of 6.6K*2K. That is, only part of the standard software development area is developed, such as areas A to C shown in FIG. 2B. The area A corresponds to the instrument panel area of the display screen, the area B corresponds to the central control area of the display screen, and the area C corresponds to the co-driver area of the display screen. Accordingly, the resolution of the area A is 3498*1040, the resolution of the area B is 3502*1040, and the resolution of the area C is 3496*1040. In the example shown in FIG. 2B, the area A and the area B are in the same row, while the area C is not in the same row as the area A and the area B.

It needs to be noted that, within the standard software development area, the location of the actual development area may be set as needed. As shown in FIG. 2C, the area A, the area B, and the area C may alternatively be in three rows. As shown in FIG. 2D, the area A, the area B, and the area C may not be edge-adjacent within the standard software development area. Moreover, the area C may not be adjacent to the area A and the area B, and similarly, the area A and the area B may be non-adjacent. The embodiments of the present disclosure do not impose specific limitations on the locates of the area A, the area B, and the area C within the standard software development area.

It needs to be noted that, in an embodiment of the present disclosure, 1K is equal to 1024 pixels.

For example, in some embodiments, the image display method provided by the embodiments of the present disclosure implements a screen splitting technique, enabling full-screen screen saver display on the display screen. In this case, the image display method may be applied to scenarios involving the display of customized elongated screen saver videos or images on the screen saver interface.

The system chip may include an SoC board card. As shown in FIG. 3, in an embodiment of the present disclosure, the standard user interface (UI) output by the SoC board card has a resolution of 8K*4K. Among the display contents of the standard UI, relevant contents are displayed only in the area A, the area B, and the area C, while the shaded areas outside the area A, the area B, and the area C display no content or display a pure color picture, such as a pure black picture. Subsequently, the image display method provided by the embodiments of the present disclosure is utilized to process the display contents in the standard user interface, the display contents are spliced based on a Field-Programmable Gate Array (FPGA) chip, and ultimately displayed as an image and/or a video on a strip-shaped vehicle-mounted display screen, for example, the vehicle-mounted display screen can achieve a full-screen display effect. It needs to be noted that, for clarity, the display effect after splicing on a vehicle as shown in FIG. 3 shows the area A, the area B, and the area C separately, however, during actual display on the display screen, the boundaries between the area A, the area B, and the area C may not be present, and the display contents corresponding to the area A, the area B, and the area C may form a whole.

In some embodiments, before obtaining the first display content, the image display method further includes: obtaining a second display content; performing a cropping operation on the second display content based on a resolution of the display screen to obtain the plurality of area display contents; and generating the first display content based on the plurality of area display contents. In the present embodiment, the image display method provided by the embodiments of the present disclosure can achieve full-screen display or split-screen display based on the customized display contents.

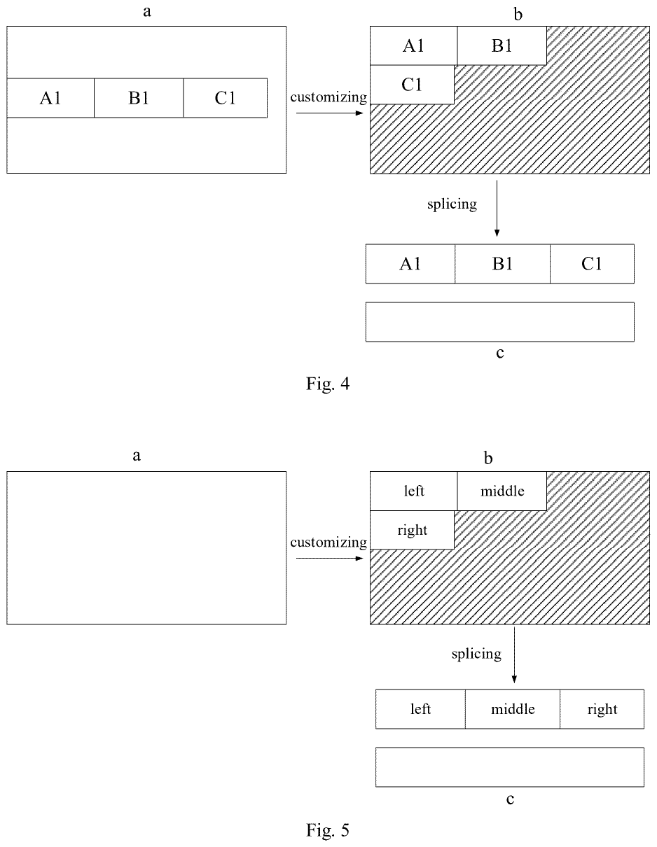

FIG. 4 is a diagram showing a process of making and displaying a customized video provided by at least one embodiment of the present disclosure.

Currently, for media data sources with a video/image aspect ratio of 16:9 or 4:3, the vehicle-mounted device employs the screen splitting technique for playing or displaying videos/images. During UI graphic design, the completeness of display should be considered from the initial UI design phase to produce media data sources. The standard video shown in diagram a of FIG. 4 may be the aforementioned second display content, with an aspect ratio of 16:9 or 4:3. During UI graphic design, the standard video represented by the diagram a needs to be custom-tailored and cropped according to the resolution of the vehicle-mounted display screen. For example, the video contents corresponding to area A1, area B1, and area C1 in the standard video are cropped to obtain a plurality of cropped video contents, and the plurality of cropped video contents may be the aforementioned plurality of area display contents. The plurality of cropped video contents are then placed into corresponding zones within the standard software development area according to set parameters to form a customized video shown in diagram b of FIG. 4, and this customized video may be the aforementioned first display content. As shown in the diagram b of FIG. 4, the area C1 originally located at the right of the area B1 may be repositioned below the area A1. This process leaves the shaded residual area within the standard software development area, as shown in the diagram b of FIG. 4. Once the customized video is made, the image display method provided by the embodiments of the present disclosure is utilized to process the customized video, thereby generating the spliced video shown in the upper portion of diagram c of FIG. 4 by splicing. Finally, the spliced video may be played on the display screen, with the display effect represented by the rectangle in the lower portion of the diagram c of FIG. 4.

In the embodiment shown in FIG. 4, a strip-shaped video is cropped from a video source of a standard proportion. The strip-shaped video includes the video contents corresponding to the area A1, the area B1, and the area C1. The location of the strip-shaped video in the video source with the standard proportion may be preset or selected by a user. For example, the video contents corresponding to the area A1 and the area B1 are continuous pictures, while the video content corresponding to the area C1 needs to be cropped from the video source with the standard proportion and spliced below the video content corresponding to the area A1, resulting in the customized video shown in the diagram b of FIG. 4. The customized video shown in the diagram b of FIG. 4 is then processed based on the image display method, ultimately achieving the full-screen display effect shown in the diagram c of FIG. 4.

For example, in some embodiments, the image display method provided by the embodiments of the present disclosure can achieve the partitioned display of a plurality of views on the display screen. In this case, the image display method may be applied to scenarios involving UI-partitioned multi-view display in a vehicle-mounted smart cockpit.

In some embodiments, before obtaining the first display content, the image display method further includes: determining a screen splitting mechanism corresponding to the display screen; partitioning the display screen according to the screen splitting mechanism to determine the plurality of display areas; generating a plurality of views according to a plurality of area sizes respectively corresponding to the plurality of display areas; generating display contents for the plurality of views to obtain the plurality of area display contents; and generating the first display content based on the plurality of area display contents.

For example, a plurality of views are in one-to-one correspondence with a plurality of display areas, and the size of the view is the same as the area size of the corresponding display area.

FIG. 5 is a diagram showing a process of displaying a plurality of views in a screen splitting manner provided by at least one embodiment of the present disclosure.

Software development is customized according to the sizes of three display areas, and the software development area is as shown in diagram a of FIG. 5. First, the screen splitting mechanism corresponding to the display screen is determined, based on the screen splitting mechanism, the display screen is partitioned to determine the plurality of display areas, for example, the display screen includes three areas and the resolutions of the three display areas are 3498*1040, 3502*1040, and 3496*1040, respectively. Then, the plurality of views are generated according to the plurality of area sizes respectively corresponding to the plurality of display areas; the display contents are generated for the plurality of views to obtain the plurality of area display contents. Finally, the first display content is generated based on the plurality of area display contents. As shown in diagram b of FIG. 5, on a normal UI design and development window, three split-screen views (left, middle, and right) are designed and laid out. Display contents are then generated for the three split-screen views to obtain three area display contents. The first display content is generated based on the three area display contents. After the display content in each view is developed and designed, the image display method provided by the embodiments of the present disclosure is utilized to process the first display content. For the embodiment shown in the diagram b of FIG. 5, the display content of a 7000*1040 area (left and middle) may be cropped starting from the top-left corner of the software development area, then, the display content of a 3498*1040 area (right) is cropped starting from the bottom-left corner of the cropped 7000*1040 area, and the display contents of the two cropped areas are then spliced together to form the spliced view shown in the upper portion of diagram c of FIG. 5. Finally, the spliced view may be displayed on the display screen. Seamless full-screen display of the three views can be achieved, as represented by the rectangle in the lower portion of the diagram c of FIG. 5.

It needs to be noted that the processes shown by the diagrams a to the diagrams b in both FIG. 4 and FIG. 5 may be implemented during the software development and design process, and are not the steps of the image display method provided by the embodiments of the present disclosure.

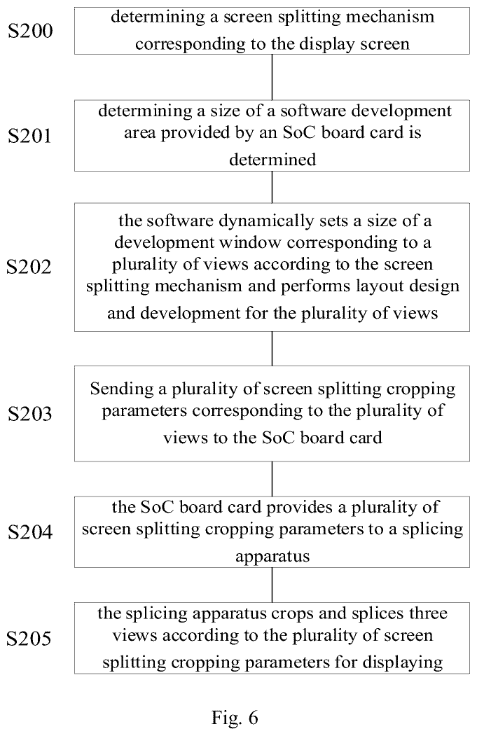

FIG. 6 is a flowchart of displaying a plurality of views in a screen splitting manner provided by at least one embodiment of the present disclosure.

As shown in FIG. 6, in step S200, a screen splitting mechanism corresponding to the display screen is determined. In step S201, a size of a software development area provided by an SoC board card is determined. In step S202, the software dynamically sets a size of a development window corresponding to a plurality of views according to the screen splitting mechanism and performs layout design and development for the plurality of views. In step S203, a plurality of screen splitting cropping parameters corresponding to the plurality of views are sent to the SoC board card. In step S204, the SoC board card provides the plurality of screen splitting cropping parameters to a splicing apparatus. In step S205, the splicing apparatus crops and splices three views according to the plurality of screen splitting cropping parameters for displaying.

For example, in some embodiments, the image display method provided by the embodiments of the present disclosure can achieve dynamic spliced display.

Currently, for a vehicle-mounted display screen, adjustments to a display color, a style, and the like of a display content source are often required during each display for reasons such as display effect, color, or style. This necessitates UI designers to repeatedly recreate a customized spliced display content, followed by software installation and replacement. This process is highly cumbersome, time-consuming, and high power consuming.

To address the above issues, the present disclosure provides a dynamic spliced display solution which eliminates the need for UI designers to repeatedly crop standard display content sources and splice the display contents. Instead, it only requires providing a normal 8K display content source and then specifying which portion of the content is to be cropped, thereby realizing automatic cropping and splicing from the normal 8K display content source. For example, the content may be cropped from the middle of the display content source by default, and software developers may select a corresponding splicing technical solution to achieve dynamic content splicing and display. This dynamic splicing display solution is implemented through software development and design. It can be implemented without the need for UI.

For example, in some embodiments, step S100 may include: obtaining an original display content; determining a cropping size based on a resolution of the display screen and a resolution of the original display content; determining a cropping start point; performing a cropping operation on the original display content based on the cropping start point and the cropping size to obtain a cropped display content; processing (e.g., scaling) the cropped display content based on the resolution of the display screen to obtain a processed display content; partitioning the processed display content to obtain the plurality of area display contents; and generating the first display content based on the plurality of area display contents.

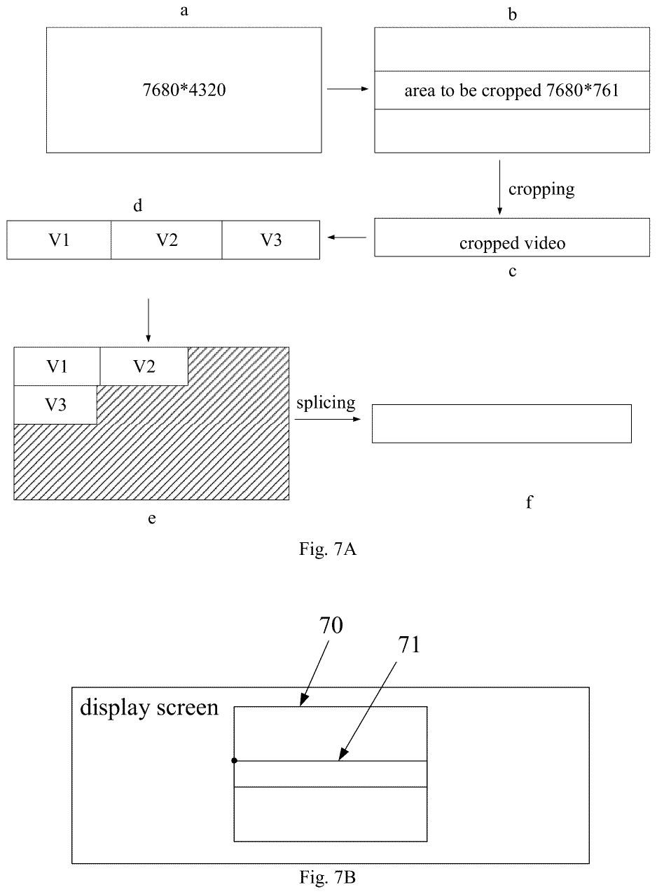

FIG. 7A is a diagram showing a process of dynamic splicing and displaying provided by at least one embodiment of the present disclosure, and FIG. 7B is a schematic diagram of determining a cropping start point provided by at least one embodiment of the present disclosure. FIG. 7A is described by taking the case where the display content is a video as an example.

As shown by diagram a of FIG. 7A, first, a video source with a resolution of 7680*4320, i.e., an original display content, is provided; then, a vehicle-mounted device determines the resolution of a vehicle-mounted display screen to be 10496*1040 via a code. A cropping size is determined according to the resolution of the vehicle-mounted display screen and the resolution of the video source. For example, the cropping size is 7680*761 (7680/10496*1040=761).

Then, a cropping start point is determined. In some examples, a location of the cropping start point is a preset location. For example, the cropping start point may be a midpoint of a left boundary of the original display content, a point corresponding to the top-left corner of the original display content, or the like. In some other examples, determining the cropping start point includes: in response to receiving a sliding operation, determining the cropping start point based on the sliding operation. As shown in FIG. 7B, a schematic frame 70 for the original display content may be displayed on the display screen, and then a cropping frame 71 is displayed in the schematic frame 70, and the cropping frame 71 corresponds to an area to be cropped as shown in diagram b of FIG. 7A. A user may perform a sliding operation by sliding the cropping frame 71, and the cropping start point may be determined based on the sliding operation. For the cropping frame 71 shown in FIG. 7B, the corresponding cropping start point is a point on the original display content mapped from the black dot in FIG. 7B. For another example, in some embodiments, a current state may be that the display screen has displayed part of the original display content, in this case, the user may perform the sliding operation on the display, and a new cropping start point may be determined based on the sliding operation, such that the remaining part of the original display content may be cropped for displaying. On this basis, the effect of sliding up and down to view the entire original display content can be achieved.

It needs to be noted that the cropping start point is not limited to the point at the top-left corner of an area to be cropped, and may alternatively be a center point, a point at the bottom-right corner, or the like of the area to be cropped.

Then, as shown in the diagram b of FIG. 7A, an area to be cropped of 7680*761 may be determined based on the cropping size and the cropping start point. Then, the cropping operation is performed on the video source in real time, that is, the area to be cropped is cropped from the video source to obtain the cropped video (i.e., the aforementioned cropped display content) shown in diagram c of FIG. 7A.

Then, since the resolution of the vehicle-mounted display screen is 10496*1040, which differs from the resolution of 7680*761 of the cropped video obtained by cropping, in order to achieve the full-screen display effect of the vehicle-mounted display screen, the cropped video may be scaled based on the resolution of the vehicle-mounted display screen, to obtain a scaled video (i.e., the aforementioned processed display content). The scaled video is then segmented according to the sizes of a plurality of display areas included in the display screen, to obtain a plurality of segmented videos. Each segmented video is correspondingly displayed on one display area. Thus, the sizes of the plurality of segmented videos may be different. As shown in diagram d of FIG. 7A, the scaled video is segmented into three segmented videos V1, V2, and V3 (i.e., the aforementioned plurality of area display contents). It needs to be noted that, in some embodiments, the scaled video may alternatively be segmented equally into a plurality of segmented videos.

Then, the segmented video V2 and the segmented video V3 are cropped. The segmented video V1 and the segmented video V2 are placed at the top-left corner of the standard display screen, while the segmented video V3 is cropped and placed directly below the segmented video V1, thereby obtaining the first display content shown in diagram e of FIG. 7A.

Finally, the first display content shown in diagram e of FIG. 7A is processed based on the image display method, thereby achieving the full-screen display effect shown in diagram f of FIG. 7A.

When each frame of the video source is played, it is cropped in the aforementioned manner, and dynamic screen splitting preprocessing is performed in advance, the normal display effect can be then achieved on the vehicle-mounted display screen, as shown in the diagram f of FIG. 7A.

When the image display method is applied to a vehicle-mounted device, the operations shown in FIG. 7A are performed by the vehicle-mounted device. During the software development and design process, a video source of the normal resolution of 8K is provided by a UI designer, and the resolution of the vehicle-mounted display screen may be determined by a developer. For example, the developer may determine the resolution of the display screen by viewing a code.

In some embodiments, the image display method provided by the embodiments of the present disclosure can realize dynamic split-screen display of applications.

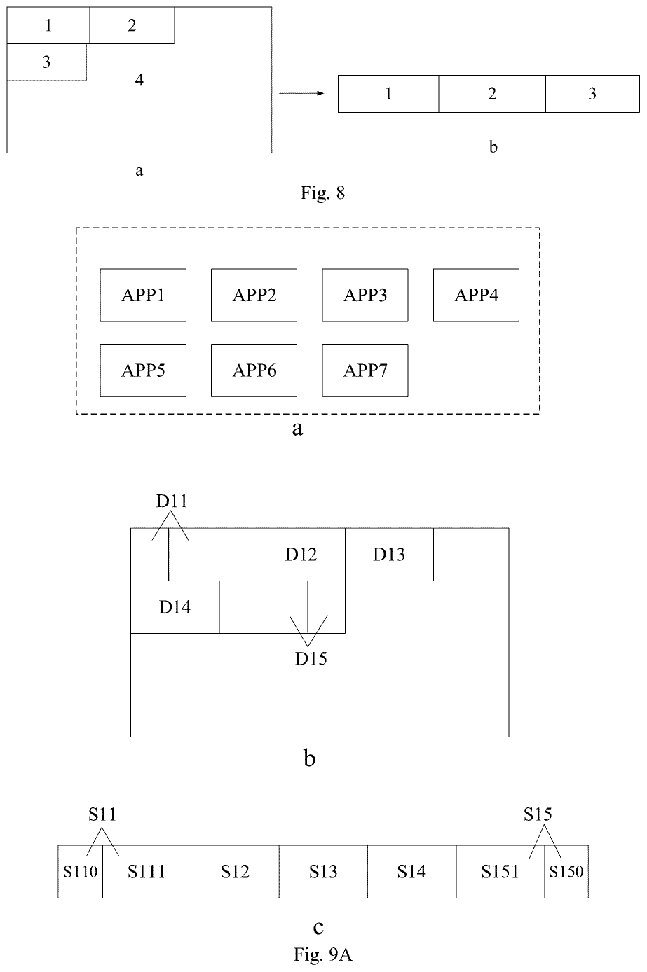

FIG. 8 is a schematic diagram of displaying an application provided by at least one embodiment of the present disclosure.

Due to the particularity of a vehicle-mounted display screen, installation display for most existing applications developed with normal aspect ratios (such as 16:9 or 4:3) is abnormal. When a normal application is installed on a vehicle-mounted system, if it is set to full-screen display by default, the normal application may display an abnormal picture with misaligned content locations, meanwhile, only the upper-left portion of the application can be displayed, preventing the entire content of the normal application from being displayed properly across the full screen. As shown in diagram a of FIG. 8, the fourth portion of the normal application actually cannot be displayed. In addition, as shown in diagram b of FIG. 8, the third portion and the second portion of the normal application are misaligned, and the correct third section is an area directly below the first portion.

To address the above issues, the present disclosure proposes a solution for dynamic screen-split display of applications. Leveraging Android's existing multi-window technology, the screen-split display of a plurality of standard third-party or self-developed applications may be realized. Normally developed applications support both portrait and landscape orientations, that is, the aspect ratios of the applications are 16:9 or 4:3. Taking 16:9 as an example, when such normal universal applications, rather than customized ones, need to be installed on vehicle-mounted systems, existing vehicle-mounted systems fail to display them normally, as demonstrated by the current issues shown in FIG. 8.

For example, in some embodiments, step S100 may include: selecting at least one application in response to a first application display instruction; setting a mapping relationship between the at least one application and the plurality of display areas to determine the plurality of area display contents; and generating the first display content based on the plurality of area display contents.

For example, the first application display instruction instructs the vehicle-mounted display screen to only display the application. When the vehicle-mounted device receives the first application display instruction, a corresponding application display mode is triggered.

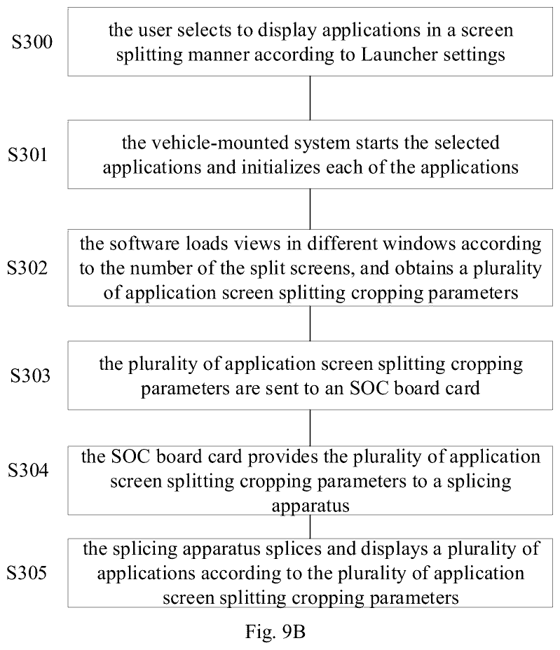

In one example, a plurality of installed applications (e.g., seven applications APP1 to APP7 shown in diagram a of FIG. 9A below) and a plurality of display areas for displaying applications may be displayed on the vehicle-mounted display screen. A user may then select one application and drag it to a corresponding display area, thereby completing the binding of the application with the display area. As a result, the application is displayed in the display area. The user may alternatively drag the application out of the display area, thereby unbinding the application from the display area. The user may alternatively drag the application from one display area to another display area, thereby unbinding the application from the display area and binding it to another display area. By repeating these operations, the user can finalize the selection of applications and thus determine the plurality of area display contents. It needs to be noted that at least one display area of the plurality of display areas may display no application. That is, an application to be displayed may be selected only for part of the plurality of display areas.

In another example, a plurality of installed applications may be displayed on the vehicle-mounted display screen. The user may then select one or more applications according to a certain sequence. In this case, the one or more applications that can be selected may be set with selection sequence numbers. A plurality of display areas have area numbers. The plurality of area display contents are determined based on a mapping relationship between the selection sequence numbers and the area numbers. For example, the mapping relationship may be that the selection sequence number is the same as the area number, that is, the selection sequence number of the application displayed in the display area is the same as the area number of the display area. Furthermore, the user may cancel the selection of an application by long-pressing or double-clicking on it. Upon cancellation, the selection sequence numbers of all applications that are selected after the deselected application are each decremented by one.

For example, a plurality of applications may be selected for each display area. On the display screen, only one application corresponding to each display area is displayed, and the user may view other applications corresponding to the display area by sliding the display screen.

For example, the resolutions of applications simultaneously displayed in different display areas may be different. For example, an application displayed in one area may have an aspect ratio of 16:9, while an application displayed in another display area may have an aspect ratio of 4:3.

In the present disclosure, considering a vehicle-mounted display screen with a resolution of 10496*1040 and a normal 8K SoC display screen with a resolution of 7680*4320, for applications with the aspect ratio of 16:9, the vehicle-mounted display screen may simultaneously display up to five applications (five applications with the resolution of 1848*1040 in terms of height, leaving a residual width of 1256 pixels, allocated equally with a width of 628 pixels on each of left and right sides). For applications with the aspect ratio of 4:3, the vehicle-mounted display screen may simultaneously display seven applications (seven applications with the resolution of 1386*1040 in terms of height, leaving a residual width of 794 pixels, allocated equally with a width of 397 pixels on each of left and right sides). In other words, in the application display mode, the size of each display area is determined based on the resolution of an application, such that the application can be displayed across the full screen. In this case, each display area displays one application at most.

FIG. 9A is a diagram showing a process of displaying an application provided by at least one embodiment of the present disclosure.

Currently, there are many applications with the aspect ratio of 16:9. Taking an application with the aspect ratio of 16:9 (with the resolution of 1848*1040) as an example, the implementation of displaying five applications on the vehicle-mounted display screen by way of example is described as follows. Upon receiving the first application display instruction, a plurality of applications already installed in the vehicle-mounted system may be displayed on the vehicle-mounted display screen. For example, the diagram a of FIG. 9A shows seven applications APP1 to APP7. The user may then select at least one application from the displayed plurality of applications by click or the like; then a mapping relationship is established between the selected at least one application and the plurality of display areas to determine the plurality of area display contents. As shown in FIG. 9A, the application APP1 may be selected and set for displaying in a display area S11 corresponding to an area D11; the application APP2 may be selected and set for displaying in a display area S12 corresponding to an area D12; and similarly, the application APP5 may be selected and set for displaying in a display area S15 corresponding to an area D15. Then, the first display content is generated based on the plurality of area display contents, as shown in diagram b of FIG. 9A. Then, the first display content shown in the diagram b of FIG. 9A is processed based on the image display method, thereby achieving the full-screen display effect shown in diagram c of FIG. 9A. As shown in the diagram c of FIG. 9A, the display area S11 includes a sub-area S110 and a sub-area S111, the sub-area S110 does not display any content, and the sub-area SI11 is configured to display the application APP1. Similarly, the display area S15 includes a sub-area S150 and a sub-area S151, the sub-area D150 does not display any content, and the sub-area S151 is configured to display the application APP5.

For the embodiment shown in the diagram b of FIG. 9A, an area of 6172*1040 (area D11 to area D13) may be cropped starting from the top-left corner of the software development area. Then, an area of 4324*1040 (area D14 to area D15) may be cropped starting from the bottom-left corner of the cropped area of 6172*1040. The two cropped areas are then spliced to obtained the spliced display content shown in the diagram c of FIG. 9A.

It needs to be noted that one or more of the plurality of display areas shown simultaneously on the display screen may not display any application. For example, the user may choose to display only 1, 2, 3, 4, or 5 applications. The specific number of applications to be displayed may be determined according to the user's actual requirements.

FIG. 9B is a flowchart of displaying an application provided by at least one embodiment of the present disclosure.

As shown in FIG. 9B, in step S300, the user selects to display applications in a screen splitting manner according to Launcher settings. In step S301, the vehicle-mounted system starts the selected applications and initializes each of the applications. In step S302, the software loads views in different windows according to the number of the split screens, and obtains a plurality of application screen splitting cropping parameters. In step S303, the plurality of application screen splitting cropping parameters are sent to an SOC board card. In step S304, the SOC board card provides the plurality of application screen splitting cropping parameters to a splicing apparatus. In step S305, the splicing apparatus splices and displays a plurality of applications according to the plurality of application screen splitting cropping parameters.

For example, in some embodiments, the image display method provided by the embodiments of the present disclosure may implement the operation of selecting an application by the user in the seat of the co-driver, thereby displaying the application in the co-driver area.

For example, in some embodiments, the plurality of display areas include at least one application display area and at least one non-application display area. The application display area represents an area in which an application may be displayed, and the non-application display area represents an area which does not display an application.

For example, in some embodiments, before obtaining the first display content, the image display method further includes: determining a screen splitting mechanism corresponding to the display screen; partitioning the display screen according to the screen splitting mechanism to determine the plurality of display areas; generating at least one view according to at least one area size respectively corresponding to the at least one non-application display area; and generating a display content for the at least one view to obtain an area display content corresponding to the at least one non-application display area.

Step S100 may include: selecting at least one application in response to a second application display instruction; setting a mapping relationship between the at least one application and the at least one application display area to determine an area display content corresponding to the at least one application display area; and generating the first display content based on the area display content corresponding to the at least one non-application display area and the area display content corresponding to the at least one application display area. For example, in this mode, each application display area may display one or more applications, or may display no application, and when a plurality of applications are displayed in an application display area, the plurality of applications may be scaled in order to guarantee the accurate proportion of the display contents. In the case where the display screen includes a plurality of application display areas, part of the plurality of application display areas may not display an application, while the other part of the plurality of application display areas may display applications.

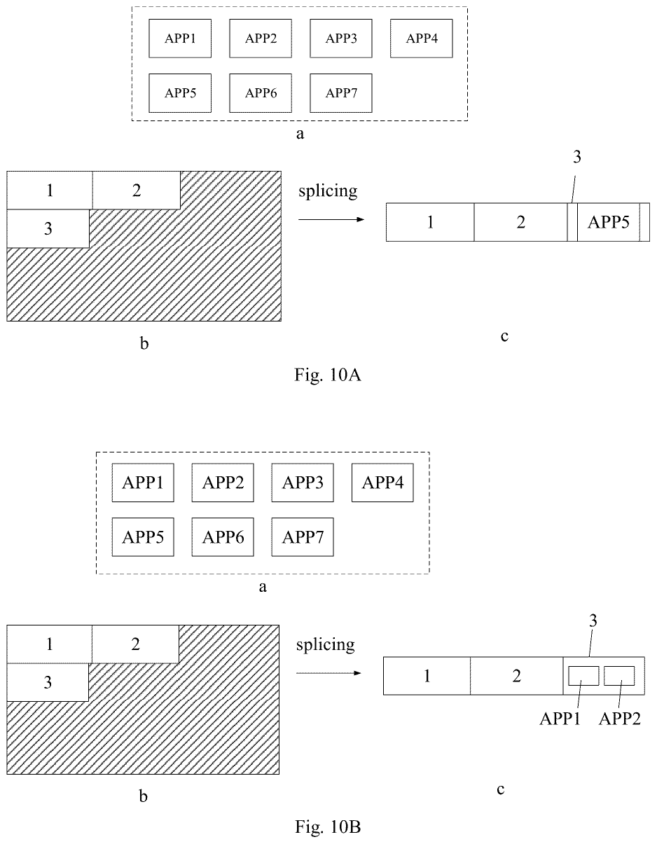

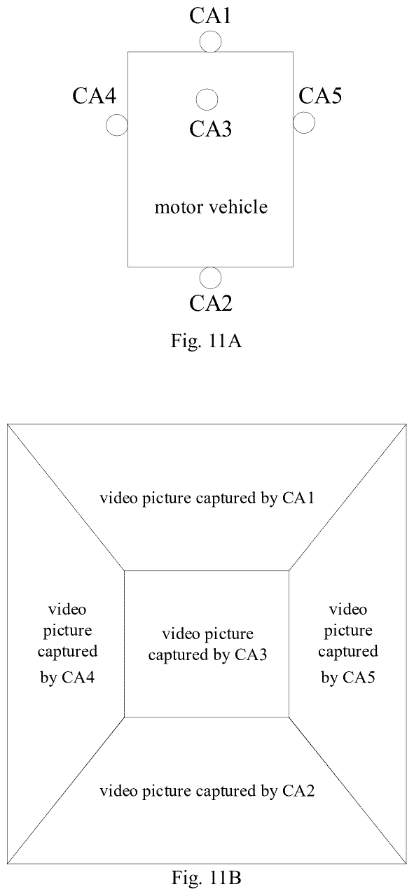

FIG. 10A is a diagram showing a process displaying one application in a co-driver area provided by at least one embodiment of the present disclosure, and FIG. 10B is a diagram showing a process displaying two applications in the co-driver area provided by at least one embodiment of the present disclosure;

Taking an application with the aspect ratio of 16:9 (with the resolution of 1848*1040) as an example, displaying an application in the co-driver area is described below by way of example. Upon receiving the second application display instruction, a plurality of applications already installed in the vehicle-mounted system may be displayed on the vehicle-mounted display screen. For example, diagrams a of FIG. 10A and FIG. 10B show 7 applications APP1 to APP7. Then, in the example shown in FIG. 10A, the user may select one application (e.g., application APP5) from the displayed plurality of applications by click or the like; then a mapping relationship is established between the selected application and the co-driver area to determine the area display content corresponding to the co-driver area. In the example shown in FIG. 10B, the user may select two applications (e.g., APP1 and APP2) from the displayed plurality of applications by click or the like; then a mapping relationship is established between the selected two applications and the co-driver area to determine the area display content corresponding to the co-driver area. As shown in diagrams b of FIG. 10A and FIG. 10B, in the software development area, an area 1 and an area 2 correspond to non-application display areas, and are an instrument panel display area and a central control display area, respectively. After the application to be displayed in the co-driver area is selected, the first display content is generated based on the area display contents respectively corresponding to the instrument panel display area and the central control display area and the area display content corresponding to the co-driver area. Then, the first display content shown in the diagram b of FIG. 10A is processed based on the image display method, ultimately resulting in the display effect shown in diagram c of FIG. 10A. The first display content shown in the diagram b of FIG. 10B is processed based on the image display method, ultimately resulting in the display effect shown in diagram c of FIG. 10B. If the user sets one application to be displayed in the co-driver area, the application may be displayed across the full screen. If the user sets a plurality of (e.g., 2) applications to be displayed in the co-driver area, the applications need to be scaled down and displayed in split screens, and then spliced for displaying. For example, in the example shown in the diagram c of FIG. 10B, the application APP1 and the application APP2 are scaled in an equal proportion to accommodate the size of the co-driver area.

It needs to be noted that, for the process of obtaining the area display contents respectively corresponding to the instrument panel display area and the central control display area, reference may be made to the embodiments described above in connection with FIG. 5, and the repeated content is not described herein again.

For example, a size of an area occupied by all applications corresponding to each application display area is smaller than or equal to a size of the application display area.

For example, in some embodiments, the image display method provided by the embodiments of the present disclosure may realize full-scene assisted driving and dynamic spliced display based on a vehicle-mounted smart cockpit. In such cases, the image display method may be applied to scenarios involving the display of surroundings of a motor vehicle based on the vehicle-mounted smart cockpit.

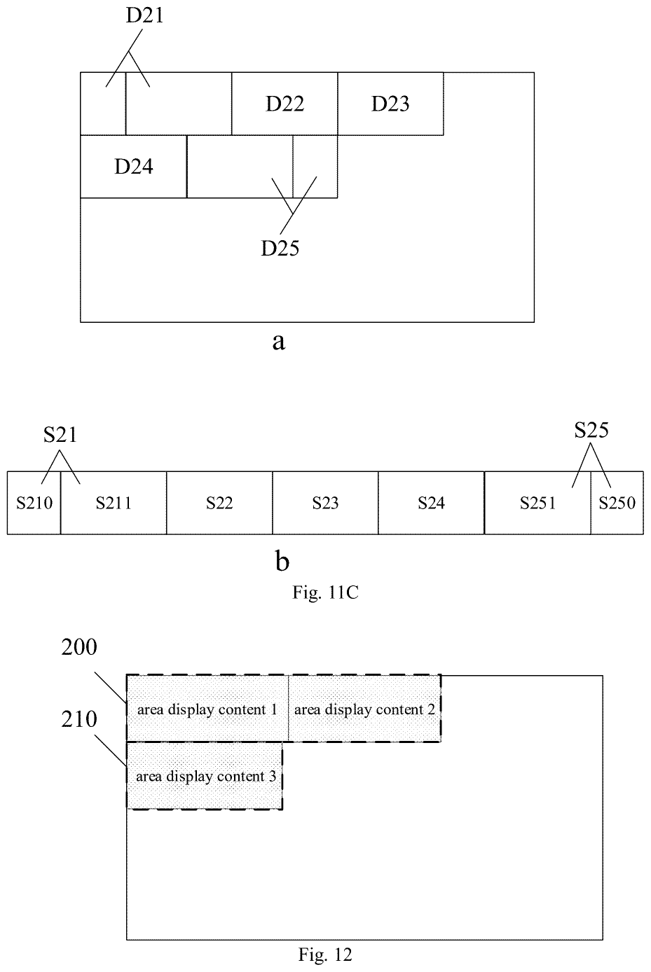

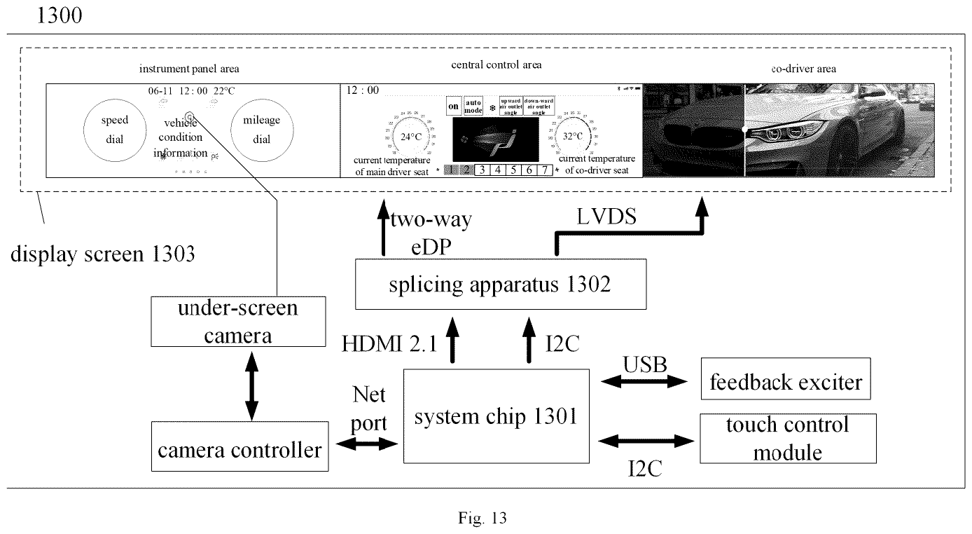

FIG. 11A is a schematic diagram of a motor vehicle provided by at least one embodiment of the present disclosure.

For example, in some embodiments, the image display method is applied to a vehicle-mounted system of a motor vehicle, the motor vehicle is capable of realizing vehicular assisted driving, to this end, the motor vehicle needing to be provided with a plurality of cameras. As shown in FIG. 11A, for example, the motor vehicle is provided with a camera CA1 at the front, a camera CA2 at the rear, a camera CA3 therein, a camera CA4 on the left side, and a camera CA5 on the right side. The full-scene assisted driving function is realized based on these five cameras.

For example, in some embodiments, step S100 may include: obtaining a plurality of shot contents respectively obtained by a plurality of cameras arranged on the motor vehicle; setting a mapping relationship between the plurality of shot contents and the plurality of display areas to determine the plurality of area display contents; and generating the first display content based on the plurality of area display contents.

FIG. 11B is a schematic diagram of a spliced full-scene assisted driving picture provided by at least one embodiment of the present disclosure.

For example, in some embodiments, the plurality of shot contents are spliced and fused to obtain a spliced shot content. For example, five cameras may capture video pictures (i.e., the shot contents are video pictures) to obtain five video pictures: a video picture captured by CA1, a video picture captured by CA2, a video picture captured by CA3, a video picture captured by CA4, and a video picture captured by CA5. For example, the five video pictures may have the same size. Subsequently, after the five video pictures are fused and spliced by an image fusion algorithm and an image splicing algorithm, the full-scene assisted driving picture (i.e., the aforementioned spliced shot content) shown in FIG. 11B may be formed. The sub-pictures within the full-scene assisted driving picture are arranged according to the positional relationships among the cameras.

If the vehicle-mounted display screen is a square screen capable of fully displaying the full-scene assisted driving picture, the spliced full-scene assisted driving picture may be directly displayed.

If the vehicle-mounted display screen is a strip-shaped display screen, in one embodiment, at least one area display content of the plurality of area display contents includes the spliced shot content. In this case, the spliced shot content may be scaled so that the spliced shot content can adapt to being displayed on the strip-shaped vehicle-mounted display screen.

If the vehicle-mounted display screen is the strip-shaped display screen, in another embodiment, as shown in FIG. 11C, the plurality of shot contents may be taken as the plurality of area display contents for the plurality of display areas respectively. As shown in diagram a of FIG. 11C, the video picture captured by CA1 may be set for displaying in a display area S21 corresponding to an area D21, the video picture captured by CA2 may be set for displaying in a display area S22 corresponding to an area D22, and similarly, the video picture captured by CA5 may be set for displaying in a display area S25 corresponding to an area D25; the first display content is then generated based on the plurality of area display contents, as shown in the diagram a of FIG. 11C. Then, the first display content shown in the diagram a of FIG. 11C is processed based on the image display method, thereby achieving the display effect shown in diagram b of FIG. 11C. As shown in the diagram b of FIG. 9A, the display area S21 includes a sub-area S210 and a sub-area S211, the sub-area S210 does not display any content, while the sub-area S211 is configured to display the video picture captured by CA1. Similarly, the display area S25 includes a sub-area S250 and a sub-area S251, the sub-area S250 does not display any content, while the sub-area S251 is configured to display the video picture captured by CA5.

For example, a display area may be divided into a plurality of sub-areas, the display content in at least one sub-area of the plurality of sub-areas include a graphic button which is clicked or touched to implement a corresponding function.

For example, the plurality of display areas include a first display area, the first display area includes a first sub-area and a second sub-area, the first sub-area is configured to display an area display content corresponding to the first display area, the second sub-area is configured to display no content, and the size of the first sub-area is greater than that of the second sub-area. For example, the first display area may be the display area S11 or the display area S15 as shown in FIG. 9A, or the display area S21 or the display area S25 as shown in FIG. 11C.

For example, the area display content corresponding to the first display area includes a first sub-area display content and a second sub-area display content, the first sub-area is configured to display the first sub-area display content, the second sub-area is configured to display the second sub-area display content. For example, the second sub-area display content may be a pure color picture, such as a pure white picture or a pure black picture; the second sub-area display content may alternatively be various images or the like. The embodiments of the present disclosure do not impose any specific limitation on the second sub-area display content.

FIG. 12 is a schematic diagram of a first display content provided by at least one embodiment of the present disclosure.

As shown in FIG. 12, the first display area includes an area display content 1, an area display content 2, and an area display content 3. In step S101, an area 200 to be spliced and an area 210 to be spliced may be determined based on locations of the area display content 1, the area display content 2, and the area display content 3 in the first display content. The area 200 to be spliced and the area 210 to be spliced are illustrated by two rectangular dashed boxes which are shaded. The area 200 to be spliced completely overlaps the areas corresponding to the area display content 1 and area display content 2, and the area 210 to be spliced completely overlaps the area corresponding to the area display content 3.

For example, in step S102, the plurality of splicing parameters include location data of the at least two areas to be spliced in the first display content. As shown in FIG. 12, the location data of the area 200 to be spliced in the first display content includes position coordinates of four vertexes of the area 200 to be spliced in the first display content, and the location data of the area 210 to be spliced in the first display content includes position coordinates of four vertexes of the area 210 to be spliced in the first display content. For example, the position coordinates of each vertex may be a splicing parameter.

For example, if the display screen includes a plurality of display sub-screens, a display sub-screen with a lowest unit pixel density among the plurality of display sub-screens is a first display sub-screen. The plurality of area display contents constitute a complete image or a complete video. In an embodiment of the present disclosure, the unit pixel density represents pixels per inch (PPI).

Step S103 includes: adjusting the plurality of area display contents based on the unit pixel density of the first display sub-screen to obtain a plurality of adjusted area display contents; and splicing the plurality of adjusted area display contents according to the plurality of splicing parameters to obtain the spliced display content.

The plurality of adjusted area display contents have the same display resolution, thereby ensuring the same display effect of the plurality of adjusted area display contents, which prevents variations in sharpness during display and avoids affecting the display effect.

For example, in some embodiments, if the display screen includes a plurality of display sub-screens, the display screen includes an instrument panel display sub-screen corresponding to the instrument panel area and a co-driver display sub-screen corresponding to the co-driver area. It needs to be noted that the display screen may further include a central control display sub-screen corresponding to the central control area, that is, the display screen may include three independent display sub-screens; alternatively, the central control area and the co-driver area may correspond to the same display sub-screen, that is, the co-driver display sub-screen may also correspond to the central control area.

For example, an under-screen camera is disposed in the instrument panel display sub-screen, an area display content corresponding to the instrument panel area includes a user state prompt. The image display method further includes: capturing, by the under-screen camera, face data of a user; determining a current state of the user based on the face data; and updating the user state prompt based on the current state of the user. Distraction detection and fatigue detection may be performed based on the face data. The user state prompt includes a distraction prompt and a fatigue prompt. The specific detection process will be described later in the following embodiments of the vehicle-mounted device.

For example, the under-screen camera may perform a capture operation at intervals of a fixed time period. The fixed time period may be a preset value or be set by the user. For example, the fixed time period may be 1 minute, 5 minutes, etc.

For example, the co-driver area may be provided with the peep-proof function. That is, the co-driver display sub-screen has the peep-proof function. For example, the peep-proof function may be achieved by providing a peep-proof screen or a peep-proof film on the co-driver display sub-screen. The peep-proof screen may be a smart view control (SVC) peep-proof screen or the like. The area display content corresponding to the central control area includes a peep-proof setting button. The image display method further includes: displaying a central control peep-proof setting adjusting sub-interface in response to receiving a click operation for the peep-proof setting button, in which the central control peep-proof setting adjusting sub-interface includes a peep-proof switch button and a peep-proof adjusting slider; turning on or turning off the peep-proof function of the co-driver area in response to receiving a click operation for the peep-proof switch button; and controlling a peep-proof area of the co-driver area in response to receiving an adjusting operation for the peep-proof adjusting slider. For example, the central control peep-proof setting adjusting sub-interface may be displayed in the central control area. The specific operation for the peep-proof function will be described later in the following embodiments of the vehicle-mounted device.

At least one embodiment of the present disclosure further provides a vehicle-mounted device. FIG. 13 is a schematic diagram of a vehicle-mounted device provided by at least one embodiment of the present disclosure. FIG. 13 illustrates an overall physical structure of a vehicle-mounted system in the vehicle-mounted device. The vehicle-mounted system may be a vehicle-mounted smart cockpit system.

As shown in FIG. 13, the vehicle-mounted device 1300 may include a system chip 1301, a splicing apparatus 1302, and a display screen 1303. The components and structures of the vehicle-mounted device 1300 shown in FIG. 13 are merely exemplary and non-limiting. As needed, the vehicle-mounted device 1300 may further include other components and structures.

The system chip 1301 is configured to: obtain a first display content, in which the first display content includes a plurality of area display contents respectively corresponding to a plurality of display areas on the display screen; determine at least two areas to be spliced in the first display content based on locations of the plurality of area display contents in the first display content; determine a plurality of splicing parameters based on the at least two areas to be spliced; and output the plurality of splicing parameters to the splicing apparatus. In other words, the system chip 1301 may implement step S100 to step S102 in the image display method described above.

The splicing apparatus 1302 is configured to splice the plurality of adjusted area display contents according to the plurality of splicing parameters to obtain the spliced display content. In other words, the splicing apparatus 1302 may implement step S103 in the image display method described above.

The display screen 1303 is configured to display the spliced display content in the plurality of display areas. In other words, the display screen 1303 may implement step S104 in the image display method described above.

For the specific description of the functions implemented by the system chip 1301, reference may be made to the relevant description of step S100 to step S102 shown in FIG. 1 in the foregoing embodiments of the image display method. For the specific description of the functions implemented by the splicing apparatus 1302, reference may be made to the relevant description of step S103 shown in FIG. 1 in the foregoing embodiments of the image display method. For the specific description of the functions implemented by the display screen 1303, reference may be made to the relevant description of step S104 shown in FIG. 1 in the foregoing embodiments of the image display method. The vehicle-mounted device 1300 may achieve the technical effects similar or identical to the image display method described above, which will not be described here redundantly.

For example, in some embodiments, the vehicle-mounted device 1300 further includes an interface design apparatus, the interface design apparatus is configured to: obtain a second display content; perform a cropping operation on the second display content based on a resolution of the display screen to obtain the plurality of area display contents; and generate the first display content based on the plurality of area display contents. In this embodiment, the system chip 1301 may be connected to the interface design apparatus to obtain the first display content from the interface design apparatus. For the specific description of the functions implemented by the interface design apparatus, reference may be made to the relevant description of FIG. 4 in the foregoing embodiments of the image display method, which will not be described here redundantly.

For example, in some embodiments, the vehicle-mounted device 1300 further includes a content generation apparatus. The content generation apparatus is configured to: obtain display contents generated for a plurality of views respectively corresponding to the plurality of display areas to obtain the plurality of area display contents; and generate the first display content based on the plurality of area display contents. The plurality of views are determined by a method as follows: determining a screen splitting mechanism corresponding to the display screen; partitioning the display screen according to the screen splitting mechanism to determine the plurality of display areas; and generating a plurality of views according to a plurality of area sizes respectively corresponding to the plurality of display areas. In this embodiment, the system chip 1301 may be connected to the content generation apparatus to obtain the first display content from the content generation apparatus. For the specific description of the process of determining the plurality of views, reference may be made to the relevant description of FIG. 5 in the foregoing embodiments of the image display method, which will not be described here redundantly.

For example, in some embodiments, when performing the operation of obtaining the first display content, the system chip 1301 is configured to: obtain an original display content; determine a cropping size based on a resolution of the display screen and a resolution of the original display content; determine a cropping start point; perform a cropping operation on the original display content based on the cropping start point and the cropping size to obtain a cropped display content; process the cropped display content based on the resolution of the display screen to obtain a processed display content; partition the processed display content to obtain the plurality of area display contents; and generate the first display content based on the plurality of area display contents. In this embodiment, the first display content is generated by the system chip 1301.

For example, in some embodiments, a location of the cropping start point is a preset location. In some other embodiments, when performing the operation of determining the cropping start point, the system chip 1301 is configured to, in response to receiving a sliding operation, determine the cropping start point based on the sliding operation.

For example, in some embodiments, when performing the operation of obtaining the first display content, the system chip 1301 is configured to: select at least one application in response to a first application display instruction; set a mapping relationship between the at least one application and the plurality of display areas to determine the plurality of area display contents; and generate the first display content based on the plurality of area display contents. In this embodiment, the first display content is generated by the system chip 1301.

For example, in some embodiments, the plurality of display areas include at least one application display area and at least one non-application display area, the vehicle-mounted device 1300 further includes a content generation apparatus which is configured to obtain a display content generated for at least one view respectively corresponding to the at least one non-application display area to obtain an area display content corresponding to the at least one non-application display area. For example, the at least one view is determined by a method as follows: determining a screen splitting mechanism corresponding to the display screen; partitioning the display screen according to the screen splitting mechanism to determine the plurality of display areas; and generating the at least one view according to at least one area size respectively corresponding to the at least one non-application display area.

When performing the operation of obtaining the first display content, the system chip 1301 is configured to: select at least one application in response to a second application display instruction; set a mapping relationship between the at least one application and the at least one application display area to determine an area display content corresponding to the at least one application display area; and generate the first display content based on the area display content corresponding to the at least one non-application display area and the area display content corresponding to the at least one application display area. In this embodiment, the first display content is generated by the system chip 1301.

For example, the vehicle-mounted device 1300 may be applied to a motor vehicle. When performing the operation of obtaining the first display content, the system chip 1301 is configured to: obtain a plurality of shot contents respectively obtained by a plurality of cameras arranged on the motor vehicle; set a mapping relationship between the plurality of shot contents and the plurality of display areas to determine the plurality of area display contents; and generate the first display content based on the plurality of area display contents.

For example, the plurality of display areas include a first display area. The first display area includes a first sub-area and a second sub-area, the first sub-area is configured to display an area display content corresponding to the first display area, and the second sub-area is configured to display no content; alternatively, the area display content corresponding to the first display area includes a first sub-area display content and a second sub-area display content, the first sub-area is configured to display the first sub-area display content, and the second sub-area is configured to display the second sub-area display content. The second sub-area display content may be a pure color picture, various images, or the like.

For example, the display screen 1303 includes a plurality of display sub-screens; and at least two of the plurality of display sub-screens have different unit pixel densities. The plurality of area display contents constitute a complete image or a complete video. A display sub-screen with a lowest unit pixel density among the plurality of display sub-screens is a first display sub-screen. When performing the operation of splicing the plurality of area display contents according to the plurality of splicing parameters to obtain the spliced display content, the splicing apparatus 1302 is configured to: adjust the plurality of area display contents based on the unit pixel density of the first display sub-screen to obtain a plurality of adjusted area display contents, in which the plurality of adjusted area display contents have a same display resolution; and splice the plurality of adjusted area display contents according to the plurality of splicing parameters to obtain the spliced display content.

For example, the plurality of splicing parameters include location data of the at least two areas to be spliced in the first display content.

The vehicle-mounted device 1300 is described below in conjunction with the physical architecture shown in FIG. 13.

For example, as shown in FIG. 13, the splicing apparatus 1302 may be connected to the display screen 1303 via a Low Voltage Differential Signaling (LVDS) interface and a two-way embedded display port (eDP) interface.

The splicing apparatus 1302 is configured to: receive the splicing parameters and the first display content transmitted by the system chip 1301, and process the first display content transmitted by the system chip 1301 based on the splicing parameters to obtain the plurality of area display contents; and then splice the plurality of area display contents to obtain the spliced display content. For example, the resolution of the spliced display content is the same as that of the display screen 1303, i.e., 10496 (pixels)*1040 (pixels). Finally, the splicing apparatus 1302 transmits the spliced display content to the display screen 1303 via the LVDS interface and the two-way eDP for displaying on the display screen 1303. For example, the splicing apparatus 1302 may output images with the resolution of 960*260 and the refresh rate of 120 Hz corresponding to the co-driver area via the LVDS interface.

For example, the system chip 1301 may include an SoC board card. As shown in FIG. 13, the vehicle-mounted device 1300 may further include an under-screen camera, a camera controller, a feedback exciter, a touch module, a memory, a WiFi network, etc. As shown in FIG. 13, in one example, a camera controller is connected to the under-screen camera so as to control the under-screen camera; the camera controller may be connected to the SoC board card in the system chip 1301 via a network interface; the feedback exciter may be connected to the SoC board card in the system chip 1301 via a Universal Serial Bus (USB); the touch module may be connected to the SoC board card in the system chip 1301 via an I2C bus; the SoC board card in the system chip 1301 may be connected to the splicing apparatus 1302 via an I2C bus and a High Definition Multimedia Interface cable, e.g., HDMI 2.1.

For example, as shown in FIG. 13, the display screen 1303 includes three display areas: an instrument panel area, a central control area, and a co-driver area. The instrument panel area is located on the left side of the display screen 1303, the central control area is located in the middle of the display screen 1303, and the co-driver area is located on the right side of the display screen 1303. It needs to be noted that the positional relationships of the instrument panel area, the central control area, and the co-driver area shown in FIG. 13 are merely exemplary. Depending on actual situations, the locations of the instrument panel area, the central control area, and the co-driver area may vary. For example, the instrument panel area needs to be changed according to the driver's position, and correspondingly, the co-driver area needs to be changed according to the passenger's position.

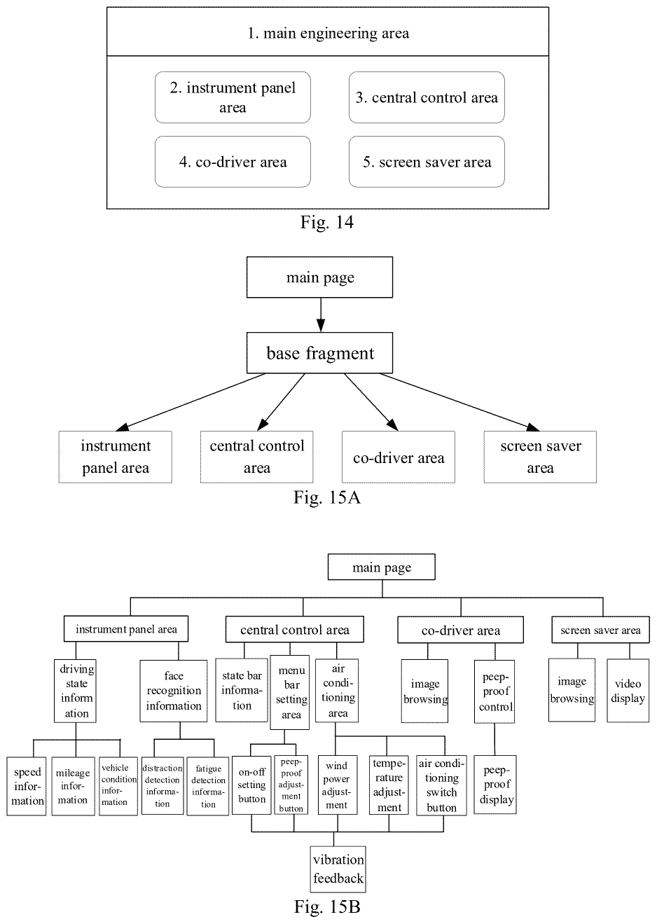

FIG. 14 is an exploded diagram of areas in a screen splitting technique provided by at least one embodiment of the present disclosure.

As shown in FIG. 14, a main engineering area serves as a master control interface and may include pages corresponding to four split-screen modules. The four split-screen modules are a left display module, a middle display module, a right display module, and a screen saver display module, respectively. The left display module corresponds to the instrument panel area, the middle display module corresponds to the central control area, the right display module corresponds to the 4, and the screen saver display module corresponds to a screen saver area.

Table 1 shows the functions of the areas in FIG. 14.

TABLE 1
Overview of Software Functions of Vehicle-Mounted System

| Area | | |
|---|---|---|
| Number | Area Name | Function Description |
| 1 | Main | After being powered on, the vehicle-mounted system |
| | Engineering | enters a main page which serves as the main engineering |
| | Area | module of the vehicle-mounted system and is configured |
| | | to activate three functional areas (the instrument panel |
| | | area, the central control area, and the co-driver area) and |
| | | also to active a full-screen screen saver. |
| 2 | Instrument | It is a display area located on the far left of the display |
| | Panel Area | screen and is configured to display vehicle state |
| | | information, including vehicle condition, mileage, and |
| | | speed. The vehicle-mounted system may support face |
| | | recognition and realize fatigue detection and distraction |
| | | detection and thus may display prompt information of |
| | | fatigue and distraction. |
| 3 | Central Control | It is a display area located in the middle of the display |
| | Area | screen and is configured to display screen saver settings, |
| | | peep-proof settings, air conditioning settings, fan speed |
| | | and temperature adjustments, air conditioning state, etc. |
| 4 | Co-driver Area | It is a display area located on the far right of the display |
| | | screen and may realize peep-proof display. It also |
| | | supports display of local videos and images. |
| 5 | Screen Saver | It is a full-screen display area for displaying full-screen |
| | Area | videos or images. |

FIG. 15A is a structural relationship diagram of a software screen split structure of a vehicle-mounted system provided by at least one embodiment of the present disclosure. FIG. 15A illustrates a hierarchical structure for implementing the screen splitting technique.

As shown in FIG. 15A, the main page is a master page. Common attributes may be extracted from the pages corresponding to the four split-screen modules, and used as the common base fragments to be encapsulated and called. The common base fragment can be called by the four split-screen modules. For example, if all the four split-screen modules have the touch function, the touch attribute may be extracted and used as a common base fragment to be encapsulated. The common base fragment is disintegrated into areas corresponding to the four split-screen modules, i.e., the instrument panel area, the central control area, the co-driver area, and the screen saver area.

FIG. 15B is an overall schematic diagram of functional modules of the vehicle-mounted system provided by at least one embodiment of the present disclosure.

As shown in FIG. 15B, the instrument panel area may display vehicle condition information and face recognition information. The driving state information includes speed information, mileage information, and vehicle condition information, and the face recognition information includes distraction detection information and fatigue detection information.

As shown in FIG. 15B, the central control area may display state bar information, a menu bar setting area, and an air conditioning area. The menu bar setting area may include an on-off setting button, a peep-proof adjustment button, and the like. The air conditioning area may include fan speed adjustment, temperature adjustment, and air conditioning switch buttons. Feedback exciters may be configured for the buttons (e.g., the on-off setting button, the peep-proof adjustment button, the wind power adjustment button, the temperature adjustment button, and the air conditioning switch button) to realize vibration feedback.

As shown in FIG. 15B, the co-driver area may support image browsing, peep-proof control (realizing peep-proof display), video display, and the like. Enabling peep-proof display in the co-driver area may effectively prevent videos or images played in the co-driver area from distracting the driver.

As shown in FIG. 15B, the screen saver area may realize image browsing and video display, turning on full-screen display of images and/or videos.

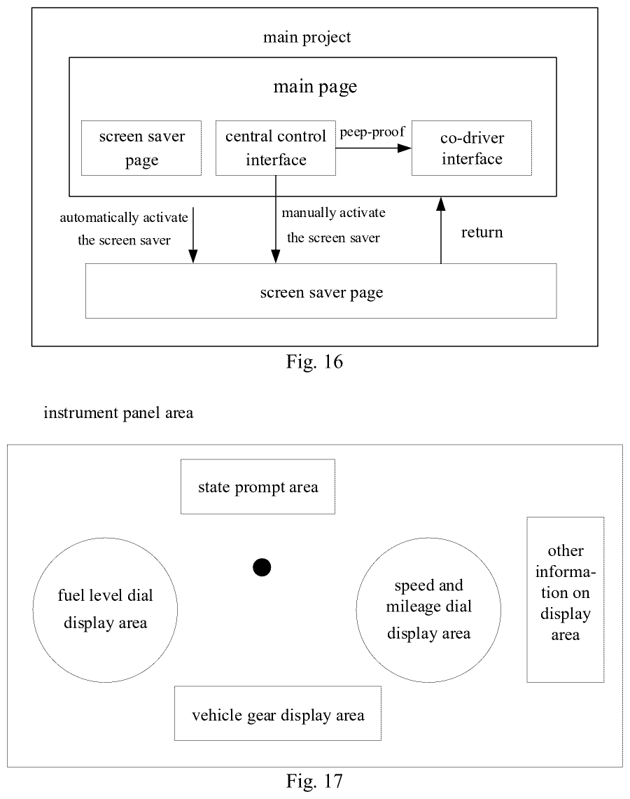

FIG. 16 is a schematic diagram of module interaction of a vehicle-mounted system provided by at least one embodiment of the present disclosure. FIG. 16 illustrates an interaction logic for implementing the screen splitting technique.

A main project Launcher APP may be established, the launcher interface controls the display and closure of the main page and a screen saver page (corresponding to the aforementioned screen saver area). The main page includes an instrument panel interface corresponding to the instrument panel area, a central control interface corresponding to the central control area, and a co-driver interface corresponding to the co-driver area. A button for controlling the peep-proof function of the co-driver area may be set in the central control interface, so as to control the peep-proof function of the co-driver area in the central control interface, e.g., turning on or turning off the peep-proof function, or adjusting the size of the peep-proof area in the co-driver area. For example, the screen saver page may be opened either automatically or manually. For example, the screen saver may be started to enter the screen saver page automatically if no any operation is performed on the main page in n minutes (e.g., 1, 2, or 5). For another example, a button (e.g., screen saver setting) for controlling the screen saver function may be provided in the central control interface, and the screen saver page may be started by clicking on the screen saver setting. In the screen saver page, any position may be clicked on for returning to the main page.

The screen saver page has a size equal to a sum of the sizes of all display areas of the display screen 1303 so as to fully cover all the display areas of the display screen 1303, thereby achieving the full-screen screen saver effect.

It needs to be noted that the user may choose to disable the function of automatically determining whether to start the screen saver display.

For example, as shown in FIG. 13, the plurality of display areas include the instrument panel area, the display screen 1303 includes the instrument panel display sub-screen corresponding to the instrument panel area; and the under-screen camera is disposed in the instrument panel display sub-screen. The area display content corresponding to the instrument panel area includes the user state prompt. The system chip 1301 is further configured to: obtain the face data of the user captured by the under-screen camera, determine the current state of the user based on the face data, and update the user state prompt based on the current state of the user.

FIG. 17 is a schematic diagram of interface elements of an instrument panel area provided by at least one embodiment of the present disclosure.

As shown in FIG. 13, the instrument panel area is located in the leftmost area of the display screen 1303. As shown in FIG. 17, the instrument panel area may include the following interface elements: user state prompt, vehicle information display (e.g., fuel level, mileage, or speed), and the like. The instrument panel area may include a state prompt area, a fuel level dial display area, a speed and mileage dial display area, a vehicle gear display area, and other information display areas. The state prompt area is configured to display the user state prompt. The fuel level dial display area is configured to show fuel level information. The speed and mileage dial display area is configured to display mileage and speed information. The vehicle gear display area is configured to indicate the vehicle gear position information. The other areas may be configured to display information such as vehicle parts and windshield wipers. As shown in FIG. 13, the instrument panel area may also display information of time, temperature, lights, safety belts, and the like.

It needs to be noted that the locations of the areas shown in FIG. 17 are merely exemplary. The locations of the areas may be set according to actual situations, and relevant areas may be added or removed.

The vehicle-mounted device 1300 may capture face data of the user with the under-screen camera. The face data is then processed based on an eye fatigue detection algorithm and a face detection algorithm to perform face and eye detection, thereby realizing distraction detection and fatigue detection of the user. The user state prompt is updated based on the detection results, and the updated user state prompt is displayed in the state prompt area.

The under-screen camera may be disposed in a portion of the display screen 1303 corresponding to the instrument panel area (e.g., the instrument panel display sub-screen). The black circle in FIG. 17 represents the location of the under-screen camera. During face and eye detection, the face state of the user is detected in real time with the under-screen camera. If the user's head is not oriented forward (e.g., when turning the head) or the user's eyes are not looking ahead, a distraction prompt is triggered. Also, the user's eye state is detected in real time with the under-screen camera. For example, if fatigue-related eye closure is detected, a fatigue prompt is triggered. In addition to displaying the user state prompt (distraction prompt and fatigue prompt) in the state prompt area, real-time voice prompts may be provided to prompt the distraction or fatigue conditions.

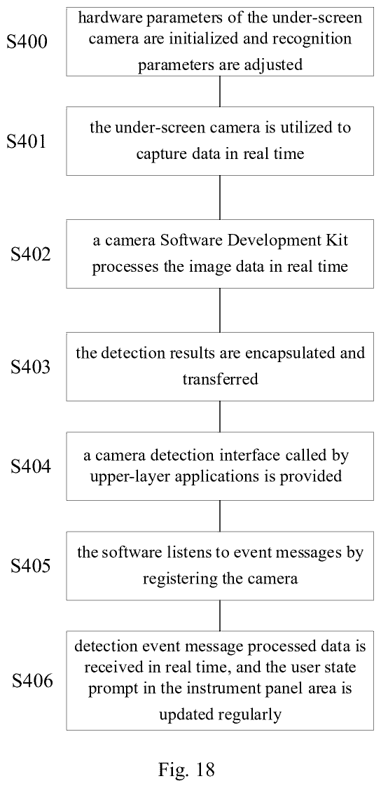

FIG. 18 is a flowchart of user state detection provided by at least one embodiment of the present disclosure. As shown in FIG. 18, first, in step S400, hardware parameters of the under-screen camera are initialized and recognition parameters are adjusted. When the vehicle-mounted device 1300 is used for the first time, the hardware parameters of the under-screen camera need to be initialized first. Simultaneously, correction parameters of the under-screen camera are adjusted based on the position and angle of the user's face relative to the under-screen camera. Face parameters can be adjusted and identified according to the data such as the distance of the user's face relative to the under-screen camera. Then, in step S401, the under-screen camera is utilized to capture data in real time. During subsequent use of the vehicle-mounted device 1300, upon entering the main page, the under-screen camera automatically actives its detection function to capture the face image data in real time. Next, in step S402, a camera Software Development Kit (SDK) processes the image data in real time. The under-screen camera may transmit the image data to the camera SDK corresponding to the camera controller such that the SDK may perform real-time processing on the image data based on the eye fatigue detection algorithm and the face detection algorithm to obtain detection results. Then, in step S403, the detection results are encapsulated and transferred. The detection results may indicate whether the user is distracted or fatigued. When the detection results indicate that there is changed data, the detection results are encapsulated via an underlying Java Archive (JAR) package and then transferred to the upper-layer application software via interface data. Then, in step S404, a camera detection interface called by upper-layer applications is provided. In step S405, the software listens to event messages by registering the camera. In step S406, detection event message processed data is received in real time, and the user state prompt in the instrument panel area is updated regularly.

For example, as shown in FIG. 13, the plurality of display areas include the co-driver area and the central control area. The display screen 1303 includes the co-driver display sub-screen corresponding to the co-driver, and the co-driver display sub-screen has the peep-proof function. The area display content corresponding to the central control area includes a peep-proof setting button. The system chip 1301 is further configured to: display a central control peep-proof setting adjusting sub-interface in response to receiving a click operation for the peep-proof setting button, in which the central control peep-proof setting adjusting sub-interface includes a peep-proof switch button and a peep-proof adjusting slider; turn on or turn off the peep-proof function of the co-driver area in response to receiving a click operation for the peep-proof switch button; and control a peep-proof area of the co-driver area in response to receiving an adjusting operation for the peep-proof adjusting slider.

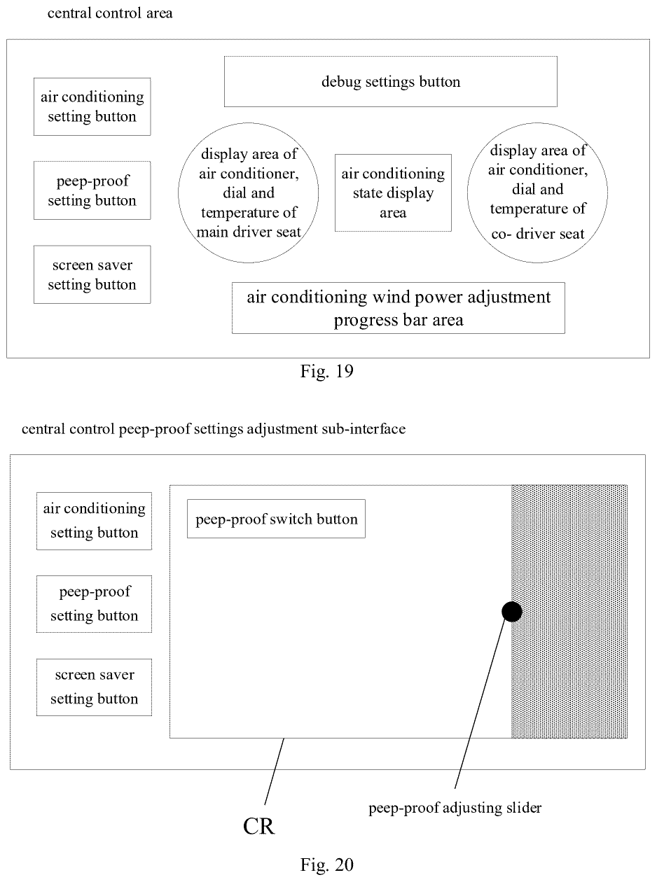

FIG. 19 is a schematic diagram of interface elements of a central control area provided by at least one embodiment of the present disclosure.

As shown in FIG. 13, the central control area is located in the middle area of the display screen 1303. As shown in FIG. 19, the central control area may include the following interface elements: a plurality of setting buttons, a main driver air conditioning dial temperature display area, a co-driver air conditioning dial temperature display area, an air conditioning state display area, and an air conditioning fan speed adjustment progress bar area, etc.

For example, FIG. 19 shows four setting buttons: an air conditioning setting button, a peep-proof setting button, a screen saver setting button, and a debugging setting button. Corresponding functions may be realized by clicking or touching the setting buttons. For example, by clicking on the debugging setting button, debugging of the air conditioner and seats is triggered. By clicking on the air conditioning setting button, the air conditioner is switched on or off. By clicking on the peep-proof setting button, switching to the central control peep-proof setting adjusting sub-interface may be triggered, and in the central control peep-proof setting adjusting sub-interface, the peep-proof function of the co-driver area may be enabled or disabled and the peep-proof area may be adjusted. By clicking on the screen saver setting button, a mode of three-split screen on the main page may be directly switched to a full-screen screen saver interface.

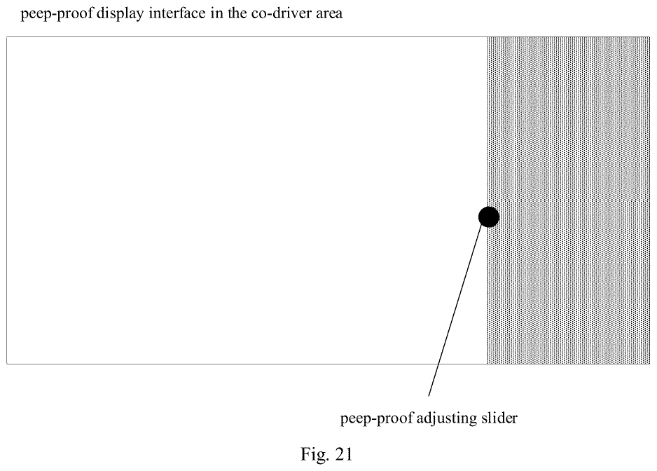

FIG. 20 is a schematic diagram of a central control peep-proof setting adjusting sub-interface provided by at least one embodiment of the present disclosure, and FIG. 21 is a schematic diagram of a peep-proof display interface of a co-driver area provided by at least one embodiment of the present disclosure. The interaction process for turning on the peep-proof function of the co-driver area is described in detail below with reference to FIG. 20 and FIG. 21.

When the user clicks on the peep-proof setting button in the central control area, jumping to the central control peep-proof setting adjusting sub-interface shown in FIG. 20 may be triggered. A peep-proof switch button and a peep-proof adjusting slider (indicated by the black circle in FIG. 20) are provided on the central control peep-proof setting adjusting sub-interface. In the central control peep-proof setting adjusting sub-interface, an area CR represents a schematic block diagram of the co-driver area, so that the user can intuitively adjust the size of the peep-proof area. By clicking on the peep-proof switch button, the peep-proof function of the co-driver area can be turned on or turned off. By sliding the peep-proof adjusting slider, the size of the peep-proof area can be adjusted. The shaded area shown in FIG. 20 represents the area with the peep-proof function within the co-driver area.

Moreover, the peep-proof effect of the co-driver area is shown in FIG. 21. The co-driver area is first provided with a peep-proof display film overlaying the screen. When the peep-proof function is turned on, the peep-proof display film becomes effective. As shown in FIG. 21, a peep-proof adjusting slider may also be provided in the co-driver area so that the user can adjust the peep-proof area more conveniently and intuitively. The co-driver area shown in FIG. 13 shows the effect of turning on the peep-proof function.

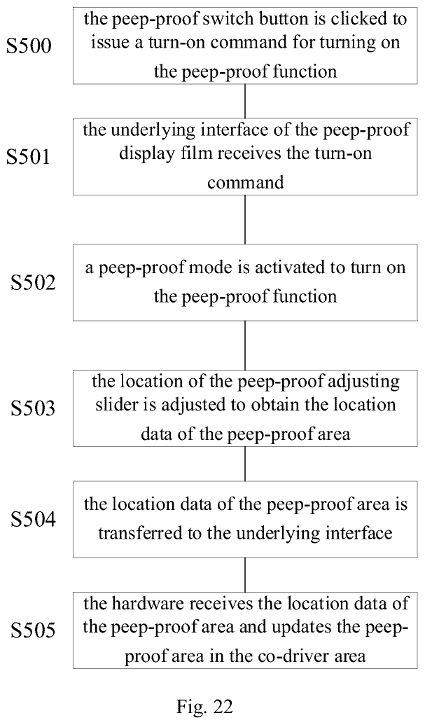

A detailed flowchart for turning on the peep-proof function is as shown in FIG. 22. As shown in FIG. 22, in step S500, the peep-proof switch button is clicked to issue a turn-on command for turning on the peep-proof function. In step S501, the underlying interface of the peep-proof display film receives the turn-on command. In step S502, a peep-proof mode is activated to turn on the peep-proof function. In step S503, the location of the peep-proof adjusting slider is adjusted to obtain the location data of the peep-proof area. In step S504, the location data of the peep-proof area is transferred to the underlying interface. In step S505, the hardware receives the location data of the peep-proof area and updates the peep-proof area in the co-driver area.

In FIG. 21, if the peep-proof function is turned off, the user may choose to play videos and/or images (e.g., videos and/or images preloaded in the vehicle-mounted device 1300, videos and/or images in a storage space accessible to USB interfaces and the like, or videos and/or images stored in cloud networks) in the co-driver area, or to open applications. It needs to be noted that the videos and/or images may be either customized videos and/or images or conventional videos and/or images. The customized videos and/or images refer to those specifically tailored to the size of the co-driver area, and may be displayed across the full screen in the co-driver area without picture deformation. The conventional videos and/or images may refer to those in existing conventional formats (e.g., 16:9 or 4:3, etc.).

As shown in FIG. 20, the peep-proof setting button remains displayed in the central control peep-proof setting adjusting sub-interface. By clicking on this button again, the central control peep-proof setting adjusting sub-interface shown in FIG. 20 is switched to the interface of the central control area shown in FIG. 19.

In FIG. 19, the central control area may display two air conditioning dials: a main driver air conditioning dial and a co-driver air conditioning dial. The main driver air conditioning dial is displayed in the main driver air conditioning dial temperature display area, and the co-driver air conditioning dial is displayed in the co-driver air conditioning dial temperature display area. The user may adjust the air conditioning temperature by sliding the air conditioning dials. The air conditioning state display area may show air conditioning state information, such as a current operating mode and fan speed state. The air conditioning fan speed adjustment progress bar area may display a fan speed adjustment progress bar. By sliding the fan speed adjusting progress bar, the fan speed of the air conditioner may be adjusted, for example, increasing from low to high. The user may set a plurality of (e.g., 5, or 7) fan speed levels by sliding the fan speed adjustment progress bar. The air conditioning fan speed adjustment progress bar area may display a plurality of fan speed levels, and by clicking on different fan speed levels, the fan speed of the air conditioner may be adjusted. For example, FIG. 13 shows seven fan speed levels.

For example, an under-screen feedback exciter may be provided in the central control area. For example, when sliding the air conditioning dial, the corresponding feedback exciter may vibrate and/or sound to prompt the user that the adjustment is in progress. Similarly, feedback exciters are provided for other click operations in the central control area. When performing the click operation, the corresponding feedback exciter may vibrate and/or sound to prompt the user that the operation is in progress. It needs to be noted that the user may enable or disable one or more feedback exciters according to actual situations.

For example, the vehicle-mounted device 1300 may be applied to various operating systems, such as Android, HarmonyOS, and iOS.

The vehicle-mounted device 1300 involves the following algorithms: an Advanced Driver Assistance System (ADAS) vehicle and pedestrian detection algorithm, an eye fatigue detection algorithm, a face detection algorithm, an image fusion algorithm, an image splicing algorithm, and the like.

For example, applications (APPs) may be installed on the vehicle-mounted device 1300, such as a vehicle desktop launcher APP, a file manager APP, a video player APP, and a camera APP. Depending on the user's actual needs, various existing or future-developed applications may also be installed, such as entertainment applications (e.g., video applications, gaming applications, or image/video processing applications), educational applications, and work-related applications.

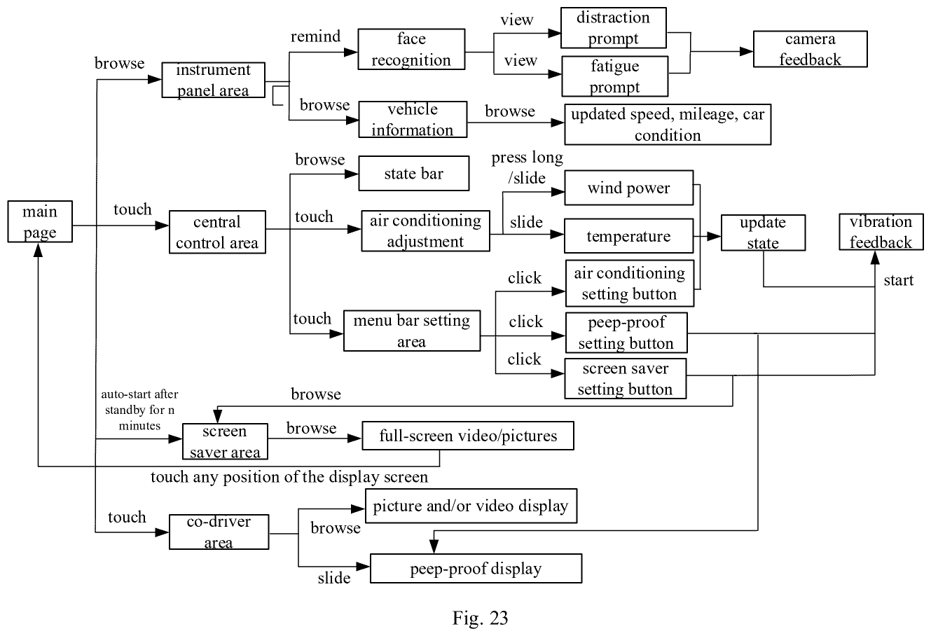

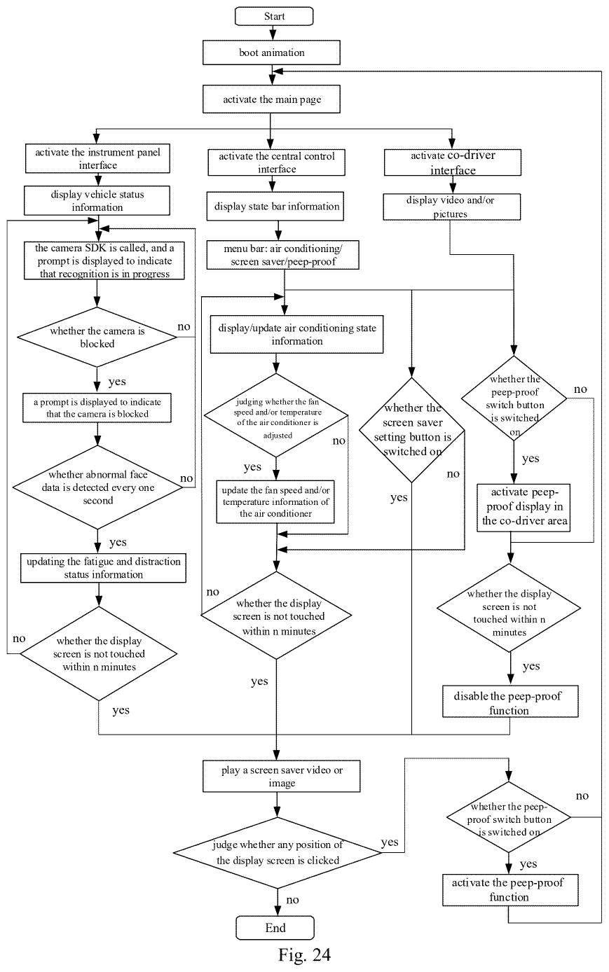

FIG. 23 is a schematic diagram of a user interaction operation provided by at least one embodiment of the present disclosure.

As shown in FIG. 23, in the main page, the user may browse the instrument panel area to obtain corresponding information and may touch the central control area to realize corresponding functions. The user may touch the co-driver area. After a standby period of n minutes (e.g., 1 minute), the screen saver may be automatically activated, entering the screen saver page to display videos or images across the full screen. Then, by touching any position of the display screen, returning to the main page can be realized.

In the instrument panel area, based on face recognition, distraction detection and fatigue detection may be performed on the user, and the user is prompted. Moreover, the user may view the distraction prompt and the fatigue prompt. Face recognition is realized by the under-screen camera detecting data in real time. Furthermore, the user may browse vehicle information, e.g., updated speed, mileage, or vehicle conditions.

In the central control area, the user may browse the state bar to obtain relevant information. The user may touch the air conditioning dial to adjust the air conditioning temperature and fan power. For example, the fan speed may be adjusted by long-pressing or sliding, while the temperature may be adjusted by sliding. The air conditioning state may be updated based on the operations of the user. The user may touch the menu bar setting area, e.g., click on the air conditioning setting button (for updating the air conditioning state), the peep-proof setting button, or the screen saver setting button. Feedback exciters may be configured for the buttons (e.g., the air conditioning setting button, the peep-proof setting button, and the screen saver setting button) to realize vibration feedback.

In the co-driver area, the user may browse the played images and/or videos. Furthermore, when the peep-proof function is turned, the user can adjust the peep-proof area by sliding the peep-proof adjusting slider.

FIG. 24 is an overall flowchart of a vehicle-mounted system provided by at least one embodiment of the present disclosure.

As shown in FIG. 24, when the vehicle-mounted system is started, a boot animation is first displayed; after the display of the boot animation is completed, the main page is activated. Activating the main page may include activating the instrument panel interface, the central control interface, and the co-driver interface. The instrument panel interface may display vehicle state information, the central control interface may display state bar information, and the co-driver interface may play videos and/or images.

As shown in FIG. 24, in the instrument panel interface, when the user state detection function is turned on, the camera SDK may be called, and a prompt is displayed to indicate that recognition is in progress. For example, whether the camera is blocked may be determined. When the camera is blocked (the “No” branch), a prompt is displayed to indicate that the camera is blocked. This allows the user to adjust the position or remove the object blocking the camera, enabling the camera to capture the user's face for distraction detection and fatigue detection. If the camera is not blocked (the “No” branch), the process returns to the step of calling the camera SDK and displaying a prompt indicating that recognition is in progress.

For example, during user state detection, whether abnormal face data is detected every one second may be judged. If yes, the fatigue and distraction state information is updated. If no, the process returns to the step of calling the camera SDK and displaying a prompt indicating that recognition is in progress.

Whether the display screen is not touched within n minutes (e.g., five minutes) may be judged. If yes, the screen saver is activated to play a full-screen screen saver video or image. If no, the process returns to the step of calling the camera SDK and displaying a prompt indicating that recognition is in progress.

In the screen saver state, whether any position of the display screen is clicked may be judged. If the user does not click on any position of the display screen, the process ends, and the display screen remains in the screen saver state. If the user clicks on any position of the display screen (the “Yes” branch), whether the peep-proof switch button is switched on may be judged. If the peep-proof switch button is switched on, the peep-proof function is turned on. If the peep-proof switch button is not switched on, returning to the main page is triggered.

As shown in FIG. 24, in the central control interface, the menu bar may be provided with the air conditioning setting button, the screen saver setting button, and the peep-proof setting button. The air conditioning state information may be displayed/updated.

Based on a user' operation for the air conditioning setting button, whether the fan speed and/or temperature of the air conditioner is adjusted is judged. If yes, the fan speed and/or temperature information of the air conditioner is updated. Then, whether to automatically activate the screen saver is judged. That is, whether the display screen is not touched within n minutes (e.g., five minutes) is judged. If yes, the screen saver is activated to play a full-screen screen saver video or image. If no, the process returns to the step of displaying/updating the air conditioning state information. If no, the process also proceeds to the step of determining whether to automatically activate the screen saver.

Based on a user' operation for the screen saver setting button, whether the screen saver setting button is switched on may be judged. If the screen saver setting button is switched on, the screen saver is activated to display a full-screen screen saver video or image. If the screen saver setting button is not switched on, the process proceeds to the step of judging whether to automatically activate the screen saver.

Based on a user' operation for the peep-proof setting button, whether the peep-proof switch button is switched on may be judged. If the peep-proof switch button is switched on, the peep-proof function is turned on. That is, peep-proof display is activated in the co-driver area. Then, whether to automatically activate the screen saver is judged. That is, whether the display screen is not touched within n minutes (e.g., five minutes) is determined. If yes, the peep-proof function is disabled and the screen saver is activated. If no, a video and/or image is played in the co-driver area.

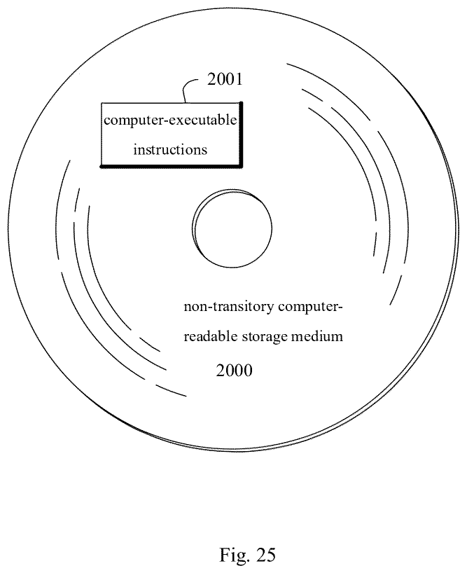

FIG. 25 is a schematic diagram of a non-transitory computer-readable storage medium provided by at least one embodiment of the present disclosure. For example, as shown in FIG. 25, one or more computer-executable instructions 2001 may be non-transitorily stored on the non-transitory computer-readable storage medium 2000. For example, when the computer-executable instructions 2001 are executed by a processor, one or more steps of the image display method described above may be performed.

The processor may be a central processing unit (CPU), a network processor (NP), or the like; or may be a digital signal processer (DSP), an application-specific integrated circuit (ASIC), a field-programmable gate array (FPGA), another programmable logic device, a discrete gate or transistor logic device, or a discrete hardware component. The CPU may be an X86 or ARM architecture or the like.

For example, the non-transitory computer-readable storage medium 2000 may be applied to the vehicle-mounted device 1300 described above.

For example, the non-transitory computer-readable storage medium 2000 may include any combination of one or more computer program products. The computer program products may include computer-readable storage mediums in various forms, e.g., a volatile memory and/or a nonvolatile memory. The volatile memory may include, for example, a random access memory (RAM) and/or a cache, etc. The nonvolatile memory may include, for example, a read only memory (ROM), a hard disk, an erasable programmable read-only memory (EPROM), a compact disk read-only memory (CD-ROM) a USB memory, a flash memory, etc. Various applications and various kinds of data may also be stored on the non-transitory computer-readable storage medium 2000.

For the present disclosure, the following statements should be noted:
(1) The accompanying drawings involve only the structure(s) in connection with the embodiment(s) of the present disclosure, and other structure(s) can be referred to common design(s).
(2) For the sake of clarity, the thickness and size of layers or structures are exaggerated in the drawings used to describe embodiments of the present invention. It will be understood that when an element such as a layer, film, region or substrate is referred to as being “on” or “under” another element, the element may be “directly” on or “under” another element, or intervening elements may be present.
(3) In case of no conflict, the embodiments of the present disclosure and the features in the embodiments can be combined with each other to obtain new embodiments.

What have been described above are only specific implementations of the present disclosure, the protection scope of the present disclosure is not limited thereto, and the protection scope of the present disclosure should be based on the protection scope of the claims.

1. An image display method, comprising:
obtaining a first display content, wherein the first display content comprises a plurality of area display contents respectively corresponding to a plurality of display areas on a display screen;
determining at least two areas to be spliced in the first display content based on locations of the plurality of area display contents in the first display content;
determining a plurality of splicing parameters based on the at least two areas to be spliced;
splicing the plurality of area display contents according to the plurality of splicing parameters to obtain a spliced display content; and
displaying the spliced display content in the plurality of display areas on the display screen.

2. The image display method according to claim 1, before obtaining the first display content, further comprising:
obtaining a second display content;
performing a cropping operation on the second display content based on a resolution of the display screen to obtain the plurality of area display contents; and
generating the first display content based on the plurality of area display contents.

3. The image display method according to claim 1, before obtaining the first display content, further comprising:
determining a screen splitting mechanism corresponding to the display screen;
partitioning the display screen according to the screen splitting mechanism to determine the plurality of display areas;
generating a plurality of views according to a plurality of area sizes respectively corresponding to the plurality of display areas;
generating display contents for the plurality of views to obtain the plurality of area display contents; and
generating the first display content based on the plurality of area display contents.

4. The image display method according to claim 1, wherein obtaining the first display content comprises:
obtaining an original display content;
determining a cropping size based on a resolution of the display screen and a resolution of the original display content;
determining a cropping start point;
performing a cropping operation on the original display content based on the cropping start point and the cropping size to obtain a cropped display content;
processing the cropped display content based on the resolution of the display screen to obtain a processed display content;
partitioning the processed display content to obtain the plurality of area display contents; and
generating the first display content based on the plurality of area display contents.

5. The image display method according to claim 4, wherein a location of the cropping start point is a preset location.

6. The image display method according to claim 4, wherein determining the cropping start point comprises: in response to receiving a sliding operation, determining the cropping start point based on the sliding operation.

7. The image display method according to claim 1, wherein obtaining the first display content comprises:
selecting at least one application in response to a first application display instruction;
setting a mapping relationship between the at least one application and the plurality of display areas to determine the plurality of area display contents; and
generating the first display content based on the plurality of area display contents.

8. The image display method according to claim 1, wherein the plurality of display areas comprise at least one application display area and at least one non-application display area;
before obtaining the first display content, the image display method further comprises:
determining a screen splitting mechanism corresponding to the display screen;
partitioning the display screen according to the screen splitting mechanism to determine the plurality of display areas;
generating at least one view according to at least one area size respectively corresponding to the at least one non-application display area; and
generating a display content for the at least one view to obtain an area display content corresponding to the at least one non-application display area; and
obtaining the first display content comprises:
selecting at least one application in response to a second application display instruction;
setting a mapping relationship between the at least one application and the at least one application display area to determine an area display content corresponding to the at least one application display area; and
generating the first display content based on the area display content corresponding to the at least one non-application display area and the area display content corresponding to the at least one application display area.

9. The image display method according to claim 8, wherein a size of an area occupied by all applications corresponding to each application display area is smaller than or equal to a size of the application display area.

10. The image display method according to claim 1, wherein the image display method is applied to a vehicle-mounted system of a motor vehicle, and obtaining the first display content comprises:
obtaining a plurality of shot contents respectively obtained by a plurality of cameras arranged on the motor vehicle;
setting a mapping relationship between the plurality of shot contents and the plurality of display areas to determine the plurality of area display contents; and
generating the first display content based on the plurality of area display contents.

11. The image display method according to claim 1, wherein the image display method is applied to a vehicle-mounted system of a motor vehicle, and a plurality of cameras are arranged on the motor vehicle, and the plurality of cameras are configured to acquire a plurality of shot contents, respectively;
the plurality of shot contents are spliced and fused to obtain a spliced shot content; and
at least one area display content of the plurality of area display content comprises the spliced shot content.

12. The image display method according to claim 1, wherein one display area of the plurality of display areas is partitioned into a plurality of sub-areas; and
the display content in at least one sub-area of the plurality of sub-areas comprises a graphic button, and the graphic button is tapped or touched to implement a corresponding function.

13. The image display method according to claim 1, wherein resolutions of at least two display areas of the plurality of display areas are different from each other.

14. The image display method according to claim 1, wherein the plurality of display areas comprise a first display area, and the first display area comprises a first sub-area and a second sub-area;
the first sub-area is configured to display an area display content corresponding to the first display area, and the second sub-area does not display a content; or
the area display content corresponding to the first display area comprises a first sub-area display content and a second sub-area display content, the first sub-area is configured to display the first sub-area display content, and the second sub-area is configured to display the second sub-area display content.

15. The image display method according to claim 1, wherein the image display method is applied to a vehicle-mounted system, and the plurality of display areas comprise an instrument panel area, a central control area, and a co-driver area.

16. The image display method according to claim 15, wherein the display screen comprises a co-driver display sub-screen corresponding to the co-driver area, the co-driver display sub-screen has a peep-proof function, and an area display content corresponding to the central control area comprises a peep-proof setting button; and
the image display method further comprises:
displaying a central control peep-proof setting adjusting sub-interface in response to receiving a click operation for the peep-proof setting button, wherein the central control peep-proof setting adjusting sub-interface comprises a peep-proof switch button and a peep-proof adjusting slider;
turning on or turning off the peep-proof function of the co-driver area in response to receiving a click operation for the peep-proof switch button; and
controlling a peep-proof area of the co-driver area in response to receiving an adjusting operation for the peep-proof adjusting slider.

17. The image display method according to claim 15, wherein the display screen comprises an instrument panel display sub-screen corresponding to the instrument panel area, an under-screen camera is disposed in the instrument panel display sub-screen, and an area display content corresponding to the instrument panel area comprises a user state prompt; and
the image display method further comprises:
capturing, by the under-screen camera, face data of a user;
determining a current state of the user based on the face data; and
updating the user state prompt based on the current state of the user.

18. The image display method according to claim 1, wherein the plurality of area display contents constitute a complete image or a complete video, the display screen comprises a plurality of display sub-screens, and a display sub-screen with a lowest unit pixel density among the plurality of display sub-screens is a first display sub-screen;
splicing the plurality of area display contents according to the plurality of splicing parameters to obtain the spliced display content comprises:
adjusting the plurality of area display contents based on the unit pixel density of the first display sub-screen to obtain a plurality of adjusted area display contents, wherein the plurality of adjusted area display contents have a same display resolution; and
splicing the plurality of adjusted area display contents according to the plurality of splicing parameters to obtain the spliced display content.

19. (canceled)

20. A vehicle-mounted device, comprising a display screen, a splicing apparatus, and a system chip,
wherein the system chip is configured to:
obtain a first display content, wherein the first display content comprises a plurality of area display contents respectively corresponding to a plurality of display areas on a display screen;
determine at least two areas to be spliced in the first display content based on locations of the plurality of area display contents in the first display content;
determine a plurality of splicing parameters based on the at least two areas to be spliced; and
output the plurality of splicing parameters to the splicing apparatus;
the splicing apparatus is configured to splice the plurality of area display contents according to the plurality of splicing parameters to obtain a spliced display content; and
the display screen is configured to display the spliced display content in the plurality of display areas.

21-36. (canceled)

37. A non-transitory computer-readable storage medium, wherein computer-executable instructions are stored on the non-transitory computer-readable storage medium,
wherein the computer-executable instructions, when executed by a processor, cause an image display method to be implemented;
the image display method comprises:
obtaining a first display content, wherein the first display content comprises a plurality of area display contents respectively corresponding to a plurality of display areas on a display screen;
determining at least two areas to be spliced in the first display content based on locations of the plurality of area display contents in the first display content;
determining a plurality of splicing parameters based on the at least two areas to be spliced;
splicing the plurality of area display contents according to the plurality of splicing parameters to obtain a spliced display content; and
displaying the spliced display content in the plurality of display areas on the display screen.
